(19) United States
(12) Patent Application Publication
(10) Pub. No.: US 2017/0180095 A1
(43) Pub. Date: Jun. 22, 2017

(54) METHOD AND APPARATUS FOR OPERATING NARROW BANDWIDTH COMMUNICATIONS IN WIRELESS COMMUNICATION SYSTEM

(71) Applicant: Samsung Electronics Co., Ltd., Suwon-si (KR)

(72) Inventors: Peng XUE, Suwon-si (KR); Namjeong LEE, Suwon-si (KR); Cheol JEONG, Seongnam-si (KR)

(21) Appl. No.: 15/389,076

(22) Filed: Dec. 22, 2016

Related U.S. Application Data
(60) Provisional application No. 62/270,970, filed on Dec. 22, 2015.
(60) Provisional application No. 62/276,468, filed on Jan. 8, 2016.
(60) Provisional application No. 62/291,246, filed on Feb. 4, 2016.

(51) Int. Cl. H04L 5/00; H04W 28/20; H04W 72/04; H04L 27/26; H04W 72/00; H04W 76/02

(52) U.S. Cl. CPC H04L 5/0048; H04W 72/005; H04W 76/021; H04W 72/0446; H04L 27/2601; H04W 28/20

(57) ABSTRACT

The present disclosure relates to a communication method and system for converging a 5^{th}-Generation (5G) communication system for supporting higher data rates beyond a 4^{th}-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. A method of a base station (BS) for transmitting a master information block (MIB) in a wireless communication network is provided. The method includes identifying first resources reserved for transmission of a first reference signal (RS) for a first communication using a first frequency bandwidth, identifying second resources reserved for transmission of a second RS for a second communication using a second frequency bandwidth, wherein the second frequency bandwidth is narrower than the first frequency bandwidth, determining third resources for a broadcast channel of the second communication based on the first resources and the second resources, and transmitting the MIB using the third resources via the broadcast channel.

### CROSS-REFERENCE TO RELATED APPLICATION(S)

This application claims the benefit under 35 U.S.C. §119(e) of a U.S. Provisional application filed on Dec. 22, 2015 in the U.S. Patent and Trademark Office and assigned Ser. No. 62/270,970, of a U.S. Provisional application filed on Jan. 8, 2016 in the U.S. Patent and Trademark Office and assigned Ser. No. 62/276,468, and of a U.S. Provisional application filed on Feb. 4, 2016 in the U.S. Patent and Trademark Office and assigned Ser. No. 62/291,246, the entire disclosure of each of which is hereby incorporated by reference.

### TECHNICAL FIELD

The present disclosure relates to a method and an apparatus for operating narrow bandwidth communication in a wireless communication system. More particularly, the present disclosure relates to a system and a method for operating cellular internet of things (CIoT) networks.

### BACKGROUND

To meet the demand for wireless data traffic having increased since deployment of fourth generation (4G) communication systems, efforts have been made to develop an improved fifth generation (5G) or pre-5G communication system. Therefore, the 5G or pre-5G communication system is also called a ‘Beyond 4G Network’ or a ‘Post long term evolution (LTE) System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid frequency shift keying (FSK) and quadrature amplitude modulation (QAM) modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The internet, which is a human centered connectivity network where humans generate and consume information, is now evolving to the internet of things (IoT) where distributed entities, such as things, exchange and process information without human intervention. The internet of everything (IoE), which is a combination of the IoT technology and the big data processing technology through connection with a cloud server, has emerged. As technology elements, such as “sensing technology”, “wired/wireless communication and network infrastructure”, “service interface technology”, and “Security technology” have been demanded for IoT implementation, a sensor network, a machine-to-machine (M2M) communication, machine type communication (MTC), and so forth have been recently researched. Such an IoT environment may provide intelligent internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described big data processing technology may also be considered to be as an example of convergence between the 5G technology and the IoT technology.

Meanwhile, in the cellular IoT (CIoT) network, one important feature is that it requires improved coverage to enable the MTC. For example, one typical scenario is to provide water or gas metering service via CIoT networks. Currently, most existing MTC/CIoT systems are targeting low-end applications that can be handled adequately by global system for mobile communications/general packet radio service (GSM/GPRS), due to the low-cost of devices and good coverage of GSM/GPRS. However, as more and more CIoT devices are deployed in the field, this naturally increases the reliance on GSM/GPRS networks. In addition, some CIoT systems are targeting standalone deployment scenarios by re-farming a GSM carrier with a bandwidth of 200 kHz.

As LTE deployments evolve, operators would like to reduce the cost of overall network maintenance by minimizing the number of radio access technologies (RATs). MTC/CIoT is a market that is likely to continue expanding in the future. This will cost operators not only in terms of maintaining multiple RATs, but it will also prevent operators from reaping the maximum benefit out of their spectrum. Given the likely high number of MTC/CIoT devices, the overall resource they will need for service provision may be correspondingly significant, and inefficiently assigned. Therefore, it is necessary to find a new solution for migrating MTC/CIoT from GSM/GPRS to LTE networks.

In this disclosure, a new MTC/CIoT system is disclosed, which can be flexibly deployed in various ways, e.g., standalone, within the guard-band of a legacy cellular system (e.g., LTE), or within the bandwidth of a legacy cellular system (e.g., LTE).

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a communication method of a base station (BS) for transmitting a master information block (MIB) in a wireless communication network. The method includes identifying first resources reserved for transmission of a first reference signal (RS) for a first communication using a first frequency bandwidth, identifying second resources reserved for transmission of a second RS for a second communication using a second frequency bandwidth, wherein the second frequency bandwidth is narrower than the first frequency bandwidth, determining third resources for a broadcast channel of the second communication based on the first resources and the second resources, and transmitting the MIB using the third resources via the broadcast channel.

Another aspect of the present disclosure is to provide a communication method of a wireless device for receiving a MIB in a wireless communication network. The method includes identifying first resources reserved for transmission of a first reference signal (RS) for a first communication using a first frequency bandwidth, identifying second resources reserved for transmission of a second RS for a second communication using a second frequency bandwidth, wherein the second frequency bandwidth is narrower than the first frequency bandwidth, identifying third resources for a broadcast channel of the second communication based on the first resources and the second resources, and receiving the MIB using the third resources via the broadcast channel.

Third aspect of the present disclosure is to provide a wireless device for receiving a MIB in a wireless communication network. The base station includes a transceiver configured to transmit and receive a signal, and a processor configured to: identify first resources reserved for transmission of a first reference signal (RS) for a first communication using a first frequency bandwidth, identify second resources reserved for transmission of a second RS for a second communication using a second frequency bandwidth, wherein the second frequency bandwidth is narrower than the first frequency bandwidth, determine third resources for a broadcast channel of the second communication based on the first resources and the second resources, and transmit the MIB using the third resources via the broadcast channel.

Fourth aspect of the present disclosure is to provide a wireless device for receiving a master information block (MIB) in a wireless communication network. The wireless device includes a transceiver configured to transmit and receive a signal, and a processor configured to: identify first resources reserved for transmission of a first reference signal (RS) for a first communication using a first frequency bandwidth, identify second resources reserved for transmission of a second RS for a second communication using a second frequency bandwidth, wherein the second frequency bandwidth is narrower than the first frequency bandwidth, identify third resources for a broadcast channel of the second communication based on the first resources and the second resources, and receive the MIB using the third resources via the broadcast channel.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A, 1B, and 1C show an example of cellular internet of things (CIoT) system deployment scenarios according to an embodiment of the present disclosure;

FIGS. 2 and 3 show examples of narrowband IoT (NB-IoT) subframes/slot structures according to various embodiments of the present disclosure;

FIG. 4 shows an example of NB-IoT downlink frame structure according to an embodiment of the present disclosure;

FIG. 5 illustrates time synchronization by NB-primary synchronization signal (PSS)/secondary synchronization signal (SSS) transmission according to an embodiment of the present disclosure;

FIG. 6 illustrates a NB-PSS/SSS location arrangement to differentiate frequency division duplexing (FDD)/time division duplexing (TDD) or operation modes according to an embodiment of the present disclosure;

FIG. 7 illustrates a NB-PSS/SSS density arrangement to differentiate FDD/TDD or operation modes according to an embodiment of the present disclosure;

FIGS. 8 and 9 show examples of narrowband-physical broadcast channel (NB-PBCH) structure with a 640 ms transmission time interval (TTI) according to an embodiment of the present disclosure;

FIGS. 10A, 10B, 11A, 11B, 12A, and 12B show examples of NB-PBCH design (Embodiment 1) according to an embodiment of the present disclosure;

FIGS. 13A and 13B are flowcharts of base station (BS) and user equipment (UE)'s behaviors in NB-PBCH design according to an embodiment of the present disclosure;

FIGS. 14A and 14B show another example of NB-PBCH design according to an embodiment of the present disclosure;

FIGS. 15A and 15B are flowcharts of BS and UE's behaviors in NB-PBCH design according to an embodiment of the present disclosure;

FIGS. 16A and 16B show a third example of NB-PBCH design (Embodiment 3) according to an embodiment of the present disclosure;

FIGS. 17A and 17B show an example of different NB-PBCH periodicities for different operation modes according to an embodiment of the present disclosure;

FIGS. 18 and 19 are flowcharts of BS and UE′ behaviors in NB-PBCH design according to an embodiment of the present disclosure;

FIGS. 20A and 20B show a fourth example of NB-PBCH design according to an embodiment of the present disclosure;

FIG. 21 illustrates a long term evolution (LTE) cell-specific reference signal (CRS) pattern for normal cyclic prefix (CP) according to an embodiment of the present disclosure;

FIGS. 22, 23, 24, and 25 show examples of NB-IoT reference signals (NB-RS) patterns for normal CP according to an embodiment of the present disclosure;

FIGS. 26, 27, 28, and 29 show examples of NB-RS patterns for extended CP according to an embodiment of the present disclosure;

FIGS. 30A and 30B show an example of utilizing the first m orthogonal frequency-division multiplexing (OFDM) symbols (e.g., m=3) in NB-PBCH subframes in guard-band/standalone operation modes according to an embodiment of the present disclosure;

FIG. 31 is the flowchart of UE's behavior in NB-PBCH reception with assisted signaling information according to an embodiment of the present disclosure;

FIGS. 32, 33, 34, and 35 illustrate examples of NB-IoT uplink frame structures according to an embodiment of the present disclosure;

FIG. 36 shows LTE TDD Configurations according to an embodiment of the present disclosure;

FIG. 37 shows an example of assisted demodulation reference signal (DMRS) due to the segmentation of original DMRS according to an embodiment of the present disclosure;

FIG. 38 shows an example of shifted DMRS symbols to avoid DMRS segmentation according to an embodiment of the present disclosure;

FIG. 39 shows an example of data/DMRS symbol arrangement in 2 continuous legacy uplink (UL) subframes according to an embodiment of the present disclosure;

FIG. 40 shows an example of data/DMRS symbol arrangement in 1 legacy UL subframe according to an embodiment of the present disclosure;

FIG. 41 shows an example of data/DMRS symbol arrangement in 3 consecutive legacy UL subframes according to an embodiment of the present disclosure;

FIG. 42 illustrates a method of a BS for transmitting a master information block (MIB) in a wireless communication network according to an embodiment of the present disclosure;

FIG. 43 illustrates a method of a wireless device for receiving a MIB in a wireless communication network according to an embodiment of the present disclosure;

FIG. 44 is block diagram of a base station for transmitting a MIB in a wireless communication network according to an embodiment of the present disclosure; and

FIG. 45 is block diagram of a wireless device for receiving a MIB in the wireless communication network according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out steps of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

The following description of embodiments is focused on the cellular internet of things (CIoT) or the narrowband IoT (NB-IoT) of the 3^{rd} generation partnership project (3GPP) long term evolution (LTE) system. However, it should be understood by those skilled in the art that the subject matter of the present disclosure is applicable to other computer/communication systems having similar technical backgrounds and configurations without significant modifications departing from the spirit and scope of the present disclosure.

### CIoT System Deployment Scenarios

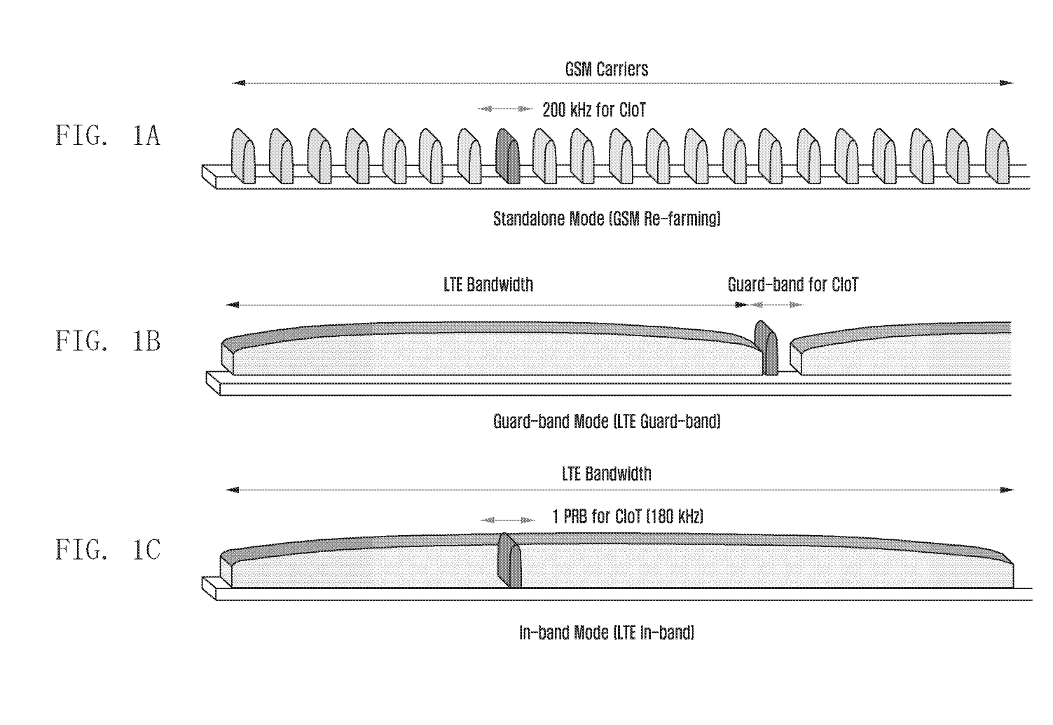

FIGS. 1A, 1B, and 1C show an example of CIoT system deployment scenarios according to an embodiment of the present disclosure.

The CIoT system occupies a narrow bandwidth, e.g., it uses a minimum system bandwidth of 200 kHz (or 180 kHz) on both downlink and uplink. Due to the narrow bandwidth feature, it can be deployed standalone, or within the guard-band of a legacy cellular system, or within the bandwidth of a legacy cellular system.

Since the physical resource block (PRB) bandwidth of a LTE system is 180 kHz, the CIoT system can be deployed in a certain PRB within the whole bandwidth, which can be called an in-band mode. Alternatively, since the LTE system usually has a guard-band from 200 kHz to 2 MHz (depending on the system bandwidth of LTE system), the CIoT system can be deployed in the guard-band region of the LTE system, which is called the guard-band mode. It can be also deployed in a standalone mode, e.g., by re-farming a global system for mobile communications (GSM) carrier with a bandwidth of 200 kHz.

### NB-IoT System Time/Frequency Structure

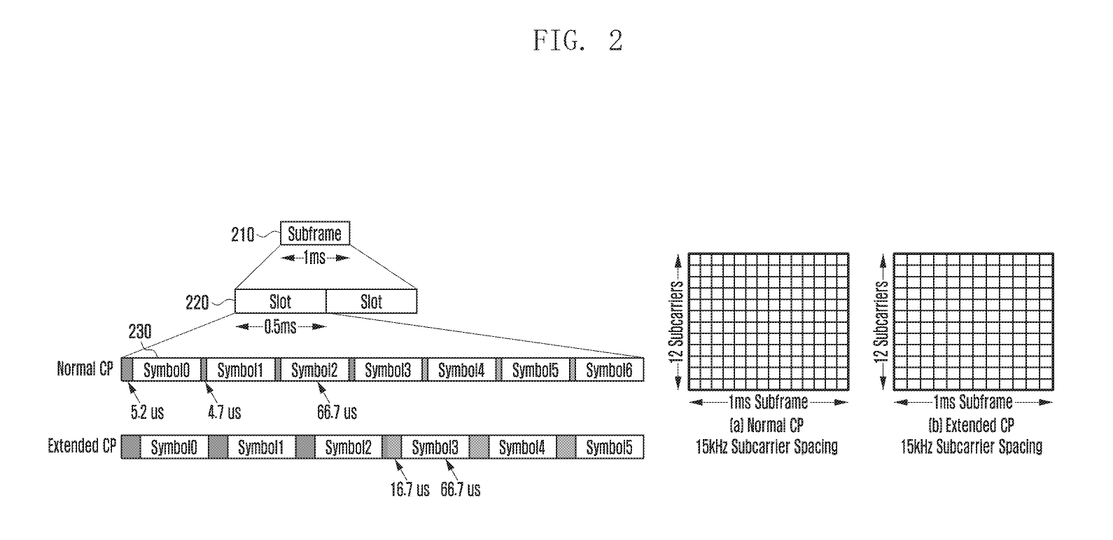

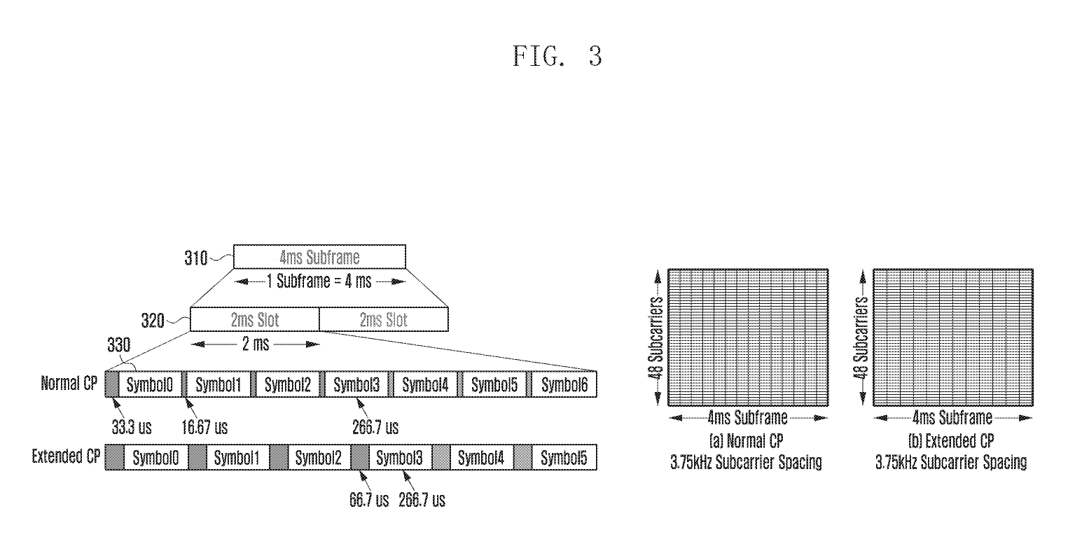

FIGS. 2 and 3 show examples of narrowband IoT (NB-IoT) subframes/slot structures according to various embodiments of the present disclosure.

It is desirable that the common system design and frame structure are considered for all the deployment scenarios. Furthermore, since the NB-IoT system supports LTE in-band deployment, the system should be designed considering compatibility and co-existence with legacy LTE system. To avoid any negative impact to the legacy LTE system, the LTE frame structure and numerology can be re-used as much as possible for NB-IoT system, e.g., waveform, sub-carrier spacing. For example, with 15 kHz subcarrier spacing, the subframe/slot structure is same as that in LTE, as shown in FIG. 2. The 15 kHz subcarrier spacing structure of FIG. 2 uses a 1 ms subframe 210, which may have two 0.5 ms slots 220. Each slot 220 may have seven symbols 230 using normal CP or six symbols 230 using extended CP. This can be considered for both downlink and uplink of NB-IoT.

Alternatively, since the transmit power of the NB-IoT device (or user equipment, UE) may be lower than that of the base station (BS), narrower subcarrier spacing, e.g., 3.75 kHz subcarrier spacing, can be considered to enhance the coverage. The scaled subframe/slot structure with 3.75 kHz subcarrier spacing is shown in FIG. 3, which assumes the same amount of cyclic prefix (CP) overhead. The subframe 310 is a 4 ms subframe, and may include two slots 320 of 2 ms each. The slots 320 may include seven symbols 330 using normal CP, or six symbols 330 using extended CP. Since the 3.75 kHz subcarrier spacing corresponds a quarter of the 15 kHz subframe/slot structure of FIG. 2, there are 48 subcarriers in a 180 kHz PRB, and the durations of symbol 330, slot 320, and subframe 310 are four times longer. If necessary, a 2 ms subframe can be also be defined.

The UE can determine a transmission scheme according to a condition of its coverage. For example, when the UE is in the bad coverage, the UE transmits data in a single subcarrier with 3.75 kHz carrier spacing. If the coverage is good, the UE transmits data in a single subcarrier or multiple subcarriers with 15 kHz carrier spacing.

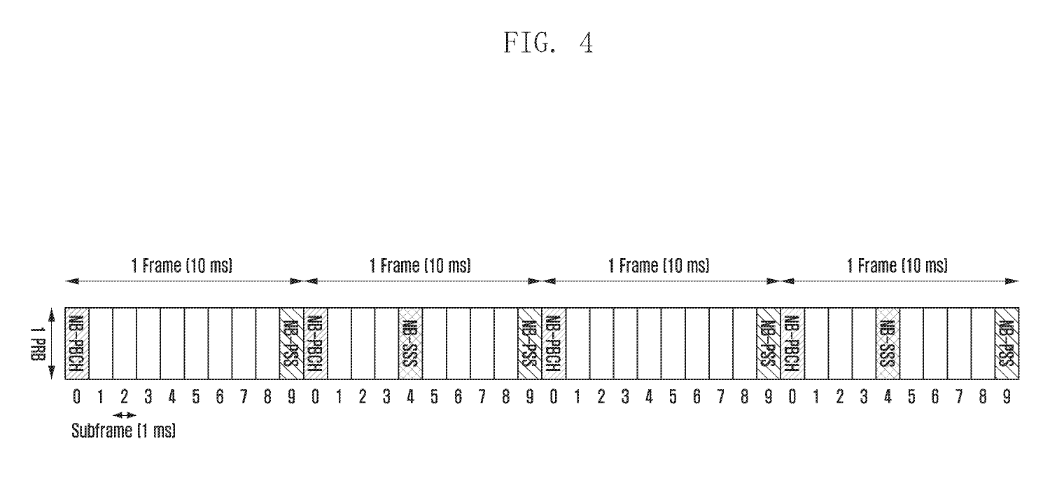

FIG. 4 shows an example of NB-IoT downlink frame structure according to an embodiment of the present disclosure. This structure is aligned with the LTE system, to make it more suitable for in-band deployment.

Similar as the LTE systems, the NB-IoT downlink has synchronization signals (i.e., NB-primary synchronization signal (NB-PSS) and NB-secondary synchronization signal (NB-SSS)), broadcast channels (i.e., NB-physical broadcast channel (NB-PBCH)), control channels (i.e., NB-physical downlink control channel (NB-PDCCH)) and data channels (i.e., NB-physical downlink shared channel (PDSCH)).

For NB-PSS, NB-SSS and NB-PBCH, it is beneficial to allocate them in the resources not collide with legacy LTE signals. The placement of NB-PSS, NB-SSS, and NB-PBCH is chosen to avoid collision with LTE cell-specific reference signal (CRS), positioning reference signal (PRS), PSS, SSS, PDCCH, physical control format indicator channel (PCFICH), physical hybrid-automatic repeat request (ARQ) indicator channel (PHICH) and multicast-broadcast single-frequency network (MBSFN) subframe. For example, in LTE frequency division duplexing (FDD) mode, Subframes #1, 2, 3, 6, 7 and 8 may correspond to MBSFN subframes. Thus, Subframe #0, 4, 5 and 9 can be considered for placement of NB-PSS/SSS and NB-PBCH.

Referring to FIG. 4, the NB-PSS may be placed in Subframe #9 every 10 ms, to avoid any potential collision with MBSFN. The NB-SSS may be placed in Subframe #4 every 20 ms. The NB-PBCH may be placed in Subframe #0 every 10 ms. The other placement is also possible, by considering the above rule of collision avoidance with legacy LTE. The remaining resources can be allocated to NB-PDCCH and NB-PDSCH.

### NB-PSS/NB-SSS Design

The NB-PSS and NB-SSS are transmitted to enable the UEs achieving time and frequency synchronization to the cell. Both NB-PSS and NB-SSS are transmitted with pre-defined density and period respectively.

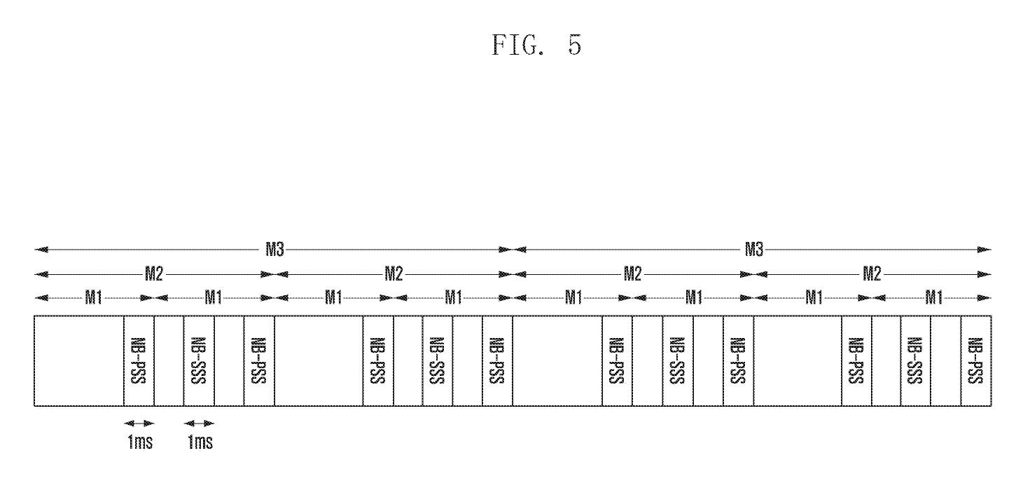

FIG. 5 illustrates time synchronization by NB-PSS/SSS transmission according to an embodiment of the present disclosure.

Referring to FIG. 5, the NB-PSS is transmitted in one subframe every M1 subframes (e.g., M1=10 or 20), and NB-SSS is transmitted in one subframe every M2 subframes (e.g., M2=10 or 20 or 40). Detecting NB-PSS can derive the boundary of M1 subframes, while detecting NB-SSS can derive the boundary of M3 subframes, where M3 maybe multiple of M2. For example, M1=20, M2=40, M3=80. The boundary of M3 subframes can be aligned with the NB-PBCH transmission time interval (TTI) for easy implementation of NB-PBCH detection.

In addition, it is also necessary for the UEs to obtain other system-specific or cell-specific information via receiving NB-PSS and NB-SSS, e.g., the CP length if the system supports more than one CP length, physical cell identification (PCID), FDD or time division duplexing (TDD) mode, operation mode, and so on. The CP length can be usually obtained by blind detection. The PCID is usually carried by the indices of NB-PSS and NB-SSS. If there are N_{Total}^{PSS} NB-PSS indices, and N_{Total}^{SSS} NB-SSS indices, there can be N_{Total}^{PSS}N_{Total}^{SSS} indications. In case that there are two NB-SSS set, e.g., NB-SSS1 and NB-SSS2, the combined indication can be expressed by N_{Total}^{PSS/SSS}=N_{Total}^{PSS}N_{Total}^{SSS}=N_{Total}^{PSS}N_{Total}^{SSS1}N_{Total}^{SSS2}.

### Mode Differentiation

To support access to different operation modes (e.g., FDD/TDD, or in-band/guard-band/standalone) of NB-IoT systems, the different modes can be differentiated in various ways.

### Embodiment 1: Indicated by NB-PSS/SSS Indices

The operation mode can be explicitly indicated by NB-PSS/SSS indices. The number of NB-PSS indices and NB-SSS indices can be designed based on the system requirement. Different combination of NB-PSS indices and NB-SSS indices can be used to differentiate the operation modes. The synchronization (NB-PSS/SSS) indices are be used to indicate the PCID only, or both PCID and operation modes. Assume that the number of PCID is 504, and 3 operation modes, 1512 indices are necessary to differentiate the PCID and operation modes. If it is only necessary to differentiate that the operation mode is in-band or not, i.e., two indications, 1008 indices are necessary. The following index configuration can be used for PCID and mode indication

N_{ID}^{PSS/SSS}=N_{Total}^{Mode}N_{ID}^{Cell,NB-IoT}+N_{ID}^{Mode}

where N_{ID}^{PSS/SSS}≦N_{Total}^{PSS/SSS}, i.e., less than the total number of possible indication combinations of NB-PSS and NB-SSS.

Here are two examples to support two or three operation mode indication, and the support with more number of indications can extended in a similar way.

### Example 1

If the number of PCID is 504, and two mode indications (in-band or not), i.e., N_{Total}^{Mode}=2, N_{ID}^{PSS/SSS}=2N_{ID}^{Cell,NB-IoT}+N_{ID}^{Mode}, where N_{ID}^{Cell,NB-IoT}ε[0,503] and N_{ID}^{Mode}ε[0,1].

### Example 2

If the number of PCID is 504, and three mode indications (in-band, guard-band, or standalone), i.e., N_{Total}^{Mode}=3, N_{ID}^{PSS/SSS}=3N_{ID}^{Cell,NB-IoT}+N_{ID}^{Mode}, where N_{ID}^{Cell,NB-IoT}ε[0,503] and N_{ID}^{Mode}ε[0,2].

### Embodiment 2: Indicated by NB-PSS/SSS Location

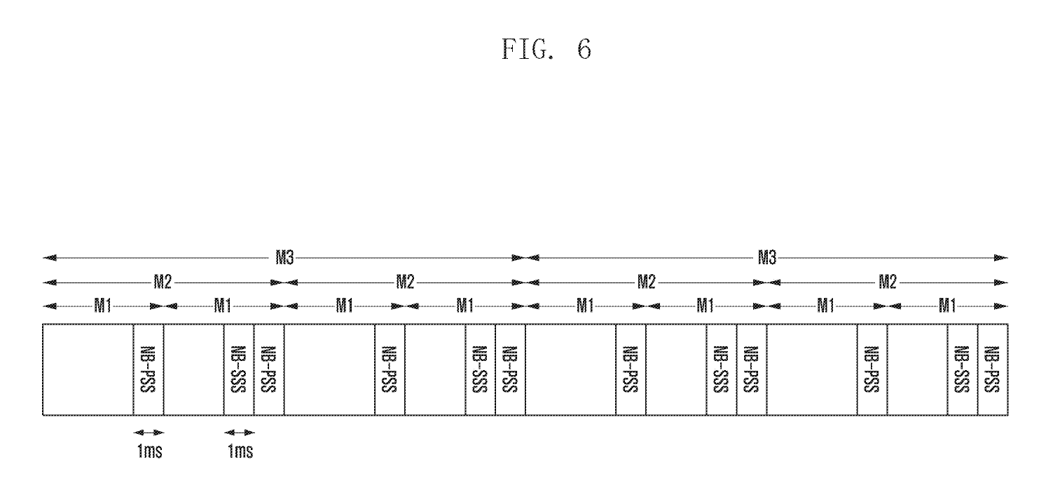

FIG. 6 illustrates a NB-PSS/SSS location arrangement to differentiate FDD/TDD or operation modes according to an embodiment of the present disclosure.

The operation mode can be explicitly indicated by NB-PSS/SSS location. Similar as the LTE case to differentiate FDD and TDD modes, different NB-SSS locations can be used to differentiate the operation modes or FDD/TDD mode. For example, different NB-PSS/SSS locations shown in FIGS. 5 and 6 can be configured for different operation modes.

### Embodiment 3: Indicated by NB-PSS/SSS Density

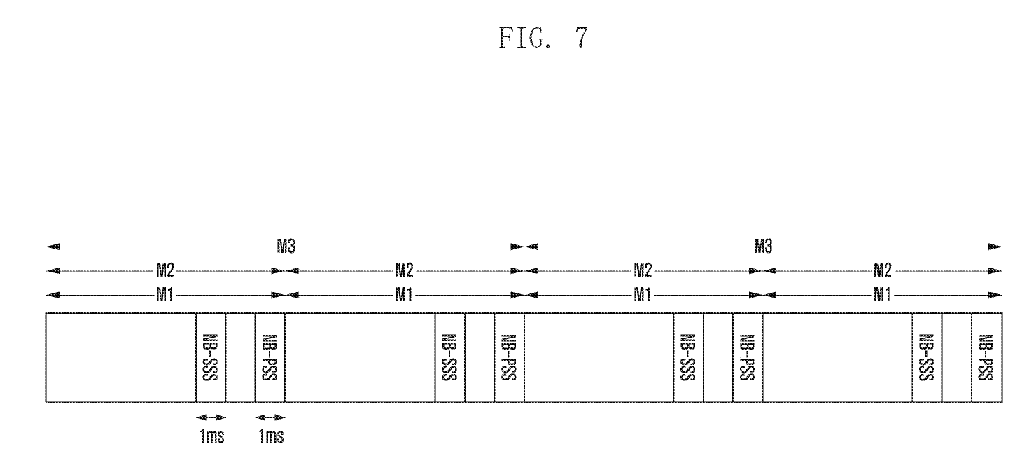

FIG. 7 illustrates a NB-PSS/SSS density arrangement to differentiate FDD/TDD or operation modes according to an embodiment of the present disclosure.

The operation mode can be explicitly indicated by NB-PSS/SSS density. Different NB-PSS/NB-SSS densities can be configured to differentiate the operation modes or FDD/TDD mode. For example, for in-band operation, high NB-PSS/SSS density can be configured due to the limited transmit power since the power may be shared with legacy LTE BS. For example, the different NB-PSS/SSS densities shown in FIGS. 5 and 7 can be configured for different operation modes.

### Embodiment 4: Indicated in the Broadcast Information

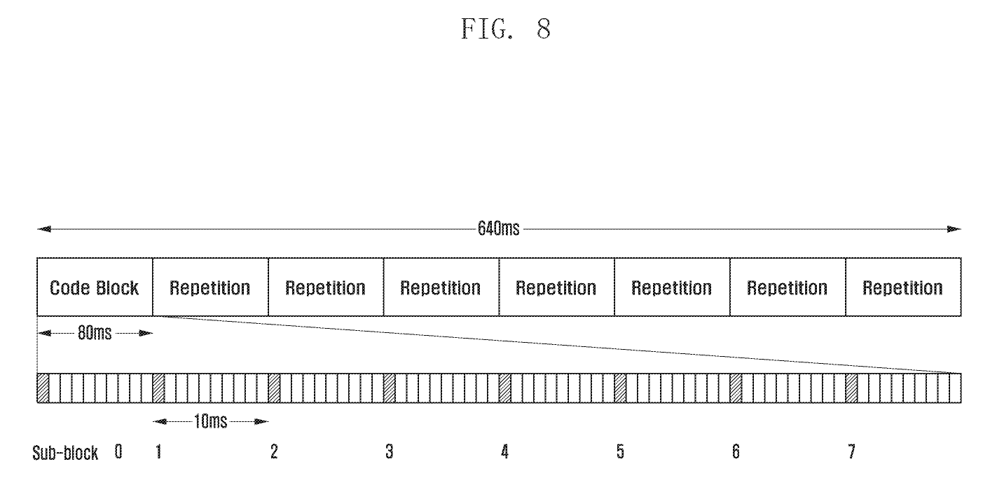

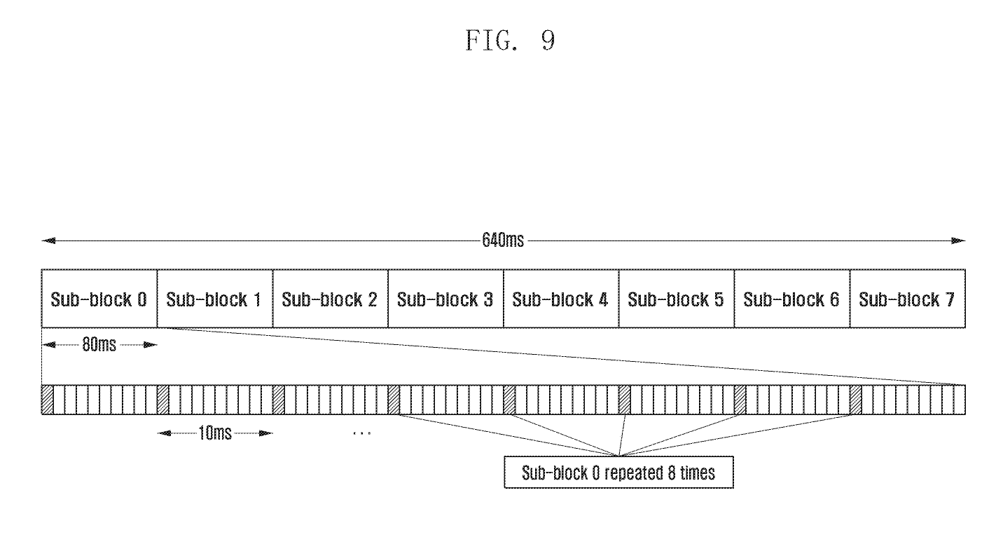

FIGS. 8 and 9 show examples of narrowband-physical broadcast channel (NB-PBCH) structure with a 640 ms transmission time interval (TTI) according to an embodiment of the present disclosure.

If the operation mode differentiation cannot be supported by NB-PSS/NB-SSS, a field of ‘Operation Mode Indication’ filed can be added in NB-master information block (NB-MIB) carried by NB-PBCH (1 bit: in-band or not; 2 bits: in-band, guard-band, standalone, reserved). In other words, the operation mode can be explicitly indicated in the broadcast information.

It is not precluded the combination of the above embodiments can be used in the system to differentiate the multiple modes, including operation modes and FDD/TDD mode, etc. After NB-PSS/SSS detection or NB-MIB reception, the NB-IoT operation mode can be determined. Then the devices can consider different processing in different operation modes. For example, in the case of in-band operation, a pre-defined number of LTE PDCCH symbols (e.g., 3) in a subframe may be not used by NB-IoT system. However, in case of guard-band and standalone operations mode, there is no such restriction. It is beneficial to differentiate the NB-IoT operation mode as early as possible for proper further processing considering the features of different operation modes.

### NB-PBCH Design

In NB-IoT system, the essential system information for initial access to a cell (called master information block, i.e., MIB) is carried on NB-PBCH. Given a NB-PBCH TTI, the NB-MIB information bits are processed and transmitted during the subframes allocated to NB-PBCH within each TTI. Assume that the NB-PBCH TTI is 640 ms and one subframe is allocated to NB-PBCH per 10 ms, there are total 64 subframes for NB-PBCH per TTI. Both coding and repetition can be used to extend the NB-PBCH transmission coverage. For example, the NB-MIB information bits (including cyclic redundancy check, i.e., CRC) can be encoded and rate matched to the number of available resource elements in 8 subframes, and then scrambled with a cell cell-specific reference sequence. Thus, the code block with size of 8 subframes can be directly repeated 8 times which spans 64 subframes and gives a 640 ms NB-PBCH TTI, as shown in FIG. 8.

Alternatively, the coded block can be segmented into 8 equal-sized code sub-blocks, and each code sub-block is repeated 8 times and spread over 80 ms time interval (one repetition in each subframe), which gives a 640 ms PBCH TTI, as shown in FIG. 9.

The structures can be easily adopted for the case of different parameter or configurations, e.g., different NB-PBCH TTI, different number of NB-PBCH subframes in a TTI.

Based on the frame structures of FIGS. 8 and 9, the embodiments of the NB-PBCH design are described. When considering in-band deployment, the following resource mapping rules are considered to avoid potential collisions with legacy LTE signals:

(1) To avoid possible collision with LTE MBSFN subframes (which may correspond to Subframes #1, 2, 3, 6, 7 or 8 in FDD mode, or in subframes 3, 4, 7, 8 or 9 in TDD mode), the NB-PBCH is transmitted in the n-th subframe (n is a pre-defined index, e.g., 0) with a pre-define periodicity, e.g., every frame (10 ms) or every two frames (20 ms).

(2) The resource elements of the first m orthogonal frequency-division multiplexing (OFDM) symbols in the n-th subframe are not allocated to NB-PBCH, to avoid collision with legacy LTE PDCCH/PCFICH/PHICH. Here, m is a pre-defined number, e.g., m=3.

(3) The legacy LTE CRS resource elements should not be affected by the NB-PBCH transmission. It is assumed here that the position of legacy CRS resource elements can be derived after cell search, e.g., assuming that the LTE cell and NB-IoT cell have the same physical cell ID for in-band operation, N_{ID}^{Cell,NB-IoT}=N_{ID}^{Cell,LTE}. At least, the same cell-specific frequency shift of the LTE cell is derived based on the NB-IoT cell ID, e.g., v_{shift}=N_{ID}^{Cell,LTE} mod 6=N_{ID}^{Cell,NB-IoT} mod 6.

Depending on how to utilize the resource elements in the n-th subframe allocated to NB-PBCH, and whether to apply the same resource mapping rule to all three operations (i.e., in-band, guard-band, standalone), there are several design options:

### Embodiment 1

Assuming that the UE may not have operation mode information at the time of NB-PBCH reception, common NB-PBCH design for all three operation modes is desirable. For all three operation modes, the NB-PBCH utilizes the resource elements in the n-th subframe, except the first m OFDM symbols, and the potential LTE CRS resource elements (assuming in-band mode with up to 4 antenna ports case).

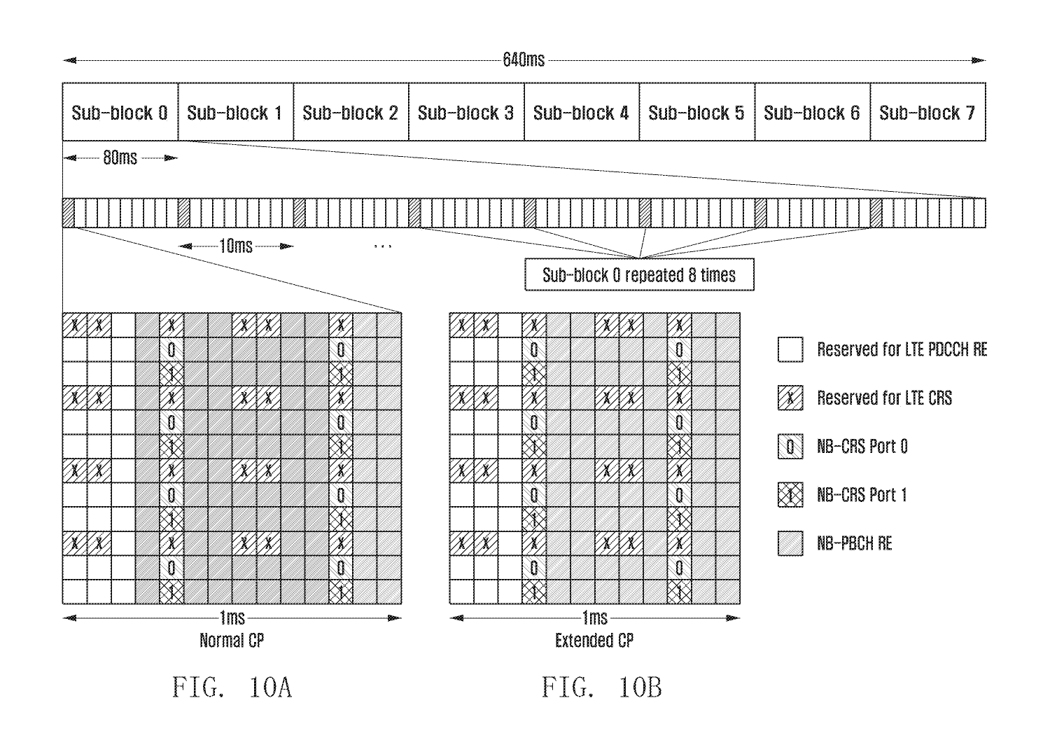

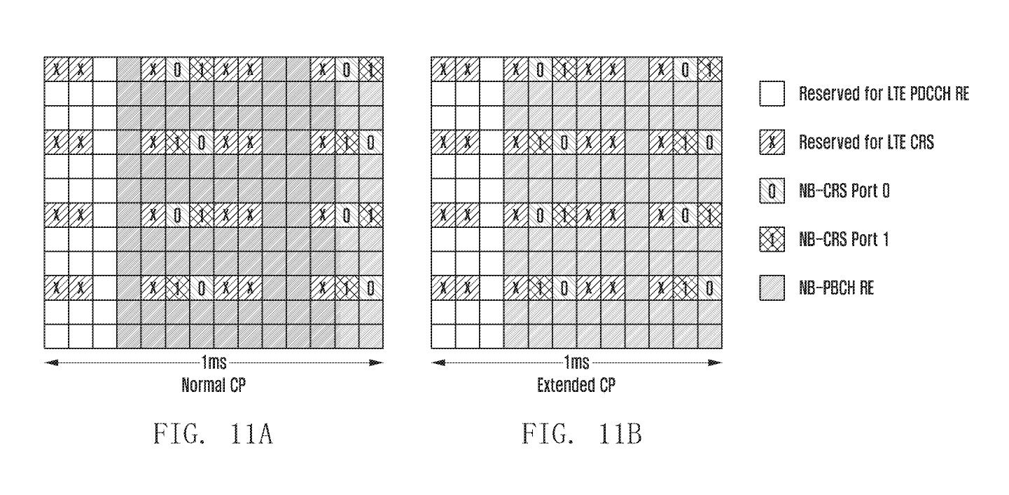

FIGS. 10A, 10B, 11A, and 11B show examples of NB-PBCH resource mapping with different NB-IoT CRS location/pattern according to an embodiment of the present disclosure.

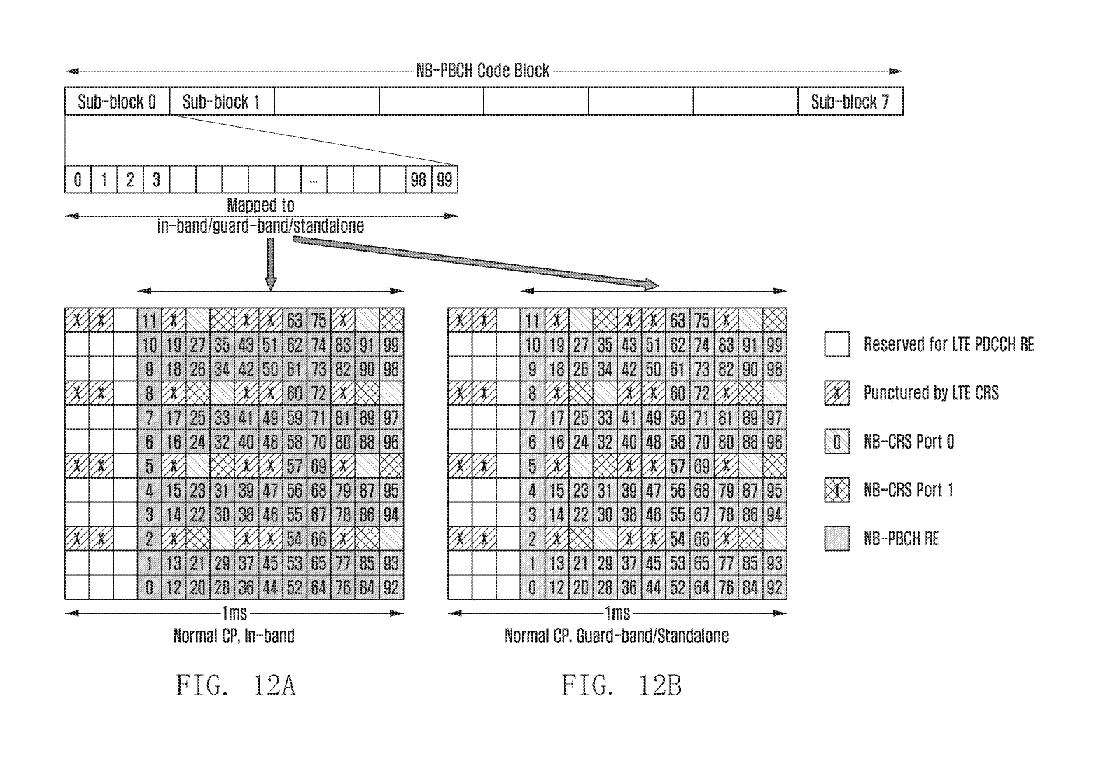

FIGS. 12A and 12B show a more detailed example of NB-PBCH resource mapping in normal CP case according to an embodiment of the present disclosure. For normal CP case, there are 100 available resource elements in each subframe for NB-PBCH resource mapping, which is common all three operations (i.e., in-band, guard-band, standalone).

### Resource Mapping Procedure in Embodiment 1

Here the resource mapping procedure of NB-PBCH in Embodiment 1 is described, assuming that the NB-PBCH TTI is 640 ms within which 64 subframes are allocated to NB-PBCH.

The block of bits b(0), . . . , b(M_{bit}−1), where M_{bit} is the number of bits transmitted on the NB-PBCH, are scrambled with a cell-specific sequence prior to modulation, resulting in a block of scrambled bits \tilde{b}(0), . . . , \tilde{b}(M_{bit}−1) according to

\tilde{b}(i)=(b(i)+c(i))mod 2

where the scrambling sequence c(i) is given by clause 7.2 of 3GPP TS 36.211. The scrambling sequence can be initialized with Cᵢₙᵢₜ=N_{ID}^{Cell,NB-IoT} in each radio frame fulfilling n_{f} mod 64=0.

The block of scrambled bits \tilde{b}(0), . . . , \tilde{b}(M_{bit}−1) are modulated as described in clause 7.1 of 3GPP TS 36.211, resulting in a block of complex-valued modulation symbols d(0), . . . , d(M_{symb}−1).

The block of modulation symbols d(0), . . . , d(M_{symb}−1) are mapped to layers according to one of clauses 6.3.3.1 or 6.3.3.3 of 3GPP TS 36.211 with M_{symb}⁽⁰⁾=M_{symb} and precoded according to one of clauses 6.3.4.1 or 6.3.4.3 of 3GPP TS 36.211, resulting in a block of vectors y(i)=[y⁽⁰⁾(i) . . . y^{(P-1)}(i)]^{T}, i=0, . . . , M_{symb}−1, where y^{(p)}(i) represents the signal for antenna port p and where p=0, . . . , P−1 and the number of antenna ports for CRSs Pε{1,2,4}. Here the NB-IoT may only support up to 2 antenna ports.

The block of complex-valued symbols y^{(p)}(0), . . . , y^{(p)}(M_{symb}−1) for each antenna port is transmitted during 64 consecutive radio frames starting in each radio frame fulfilling n_{f} mod 64=0 and shall be mapped in sequence starting with y(0) to resource elements (k, l). For all operation modes, the symbols are mapped to resource elements (k, l) not reserved for transmission of legacy LTE reference signals (assuming in-band operation) and NB-IoT reference signals (NB-RSs). The mapping to resource elements (k, l) is in increasing order of first the index k, then the index l in the OFDM symbols (except the first m OFDM symbols) in subframe n and finally the radio frame number. In each subframe, the resource element indices are given by

$$k = 0 , … , 11 , \\ l = \{ \begin{matrix}m , m + 1 , … 6 & slot 0 , for normal CP case \\ 0 , 1 , … , 6 & slot 1 , for normal CP case \\ m , m + 1 , … , 5 & slot 0 , for extended CP case \\ 0 , 1 , … , 5 & slot 1 , for extended CP case\end{matrix}$$

where the resource elements reserved for legacy LTE reference signals (assuming in-band operation) and NB-RSs shall be excluded. The mapping operation shall assume the NB-RSs with maximum number of supported antenna ports being present irrespective of the actual operation and configuration. In addition, the mapping operation assumes LTE CRSs for antenna ports 0-3 being present irrespective of the actual operation and configuration, with the resource element indices given by

$$k = v , v + 3 , v + 6 , v + 9 , where v = {N}_{ID}^{Cell , NB - IoT} mod 3$$

$$l = \{ \begin{matrix}0 , 3 , 4 & for normal CP case \\ 0 , 2 , 3 & for extended CP case\end{matrix}$$

The UEs assume that the resource elements assumed to be reserved for reference signals in the mapping operation above but not used for transmission of reference signal are not available for NB-PDSCH transmission. The UE may not make any other assumptions about these resource elements.

### BS and UE's Behaviors

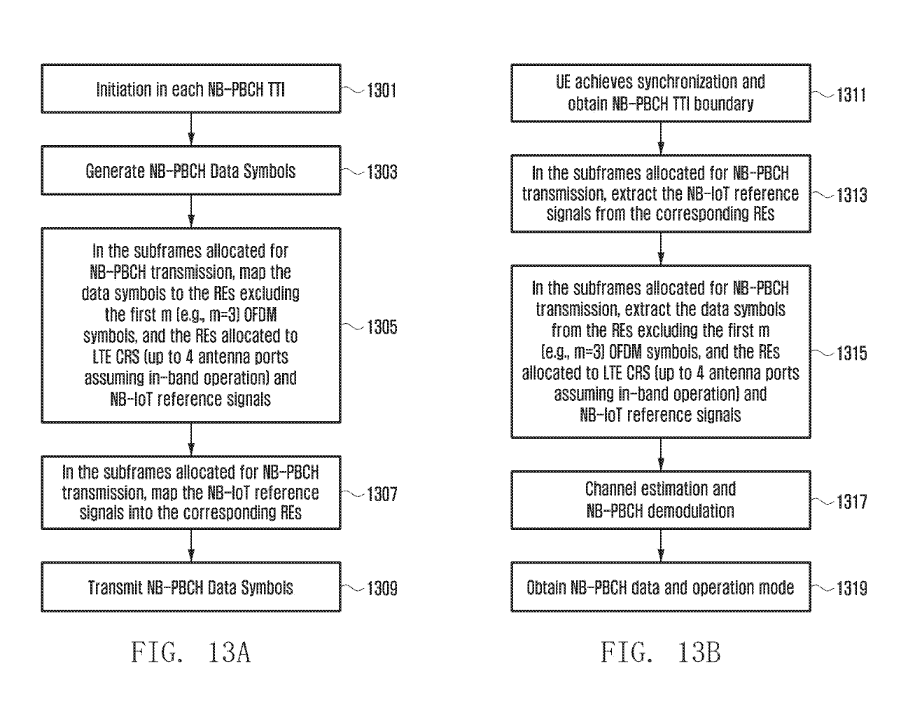

FIGS. 13A and 13B are flowcharts of BS and UE's behaviors in NB-PBCH design according to Embodiment 1 of the present disclosure.

FIG. 13A illustrates NB-PBCH transmission at the BS side, and FIG. 13B illustrates NB-PBCH reception at the UE side.

Referring to FIG. 13A, initiation is performed in each NB-PBCH TTI at operation 1301, and a BS generates NB-PBCH payload and data symbols in each NB-PBCH TTI at operation 1303. In the subframes allocated for NB-PBCH transmission, the BS maps the data symbols to the resource elements (REs) excluding the first m (e.g., m=3) OFDM symbols, and the REs allocated to LTE CRSs (up to 4 antenna ports assuming in-band operation) and NB-RSs (up to 2 antenna ports assuming maximum antenna usage case) at operation 1305. Then, in the subframes allocated for NB-PBCH transmission, the BS maps the NB-RSs into the corresponding REs at operation 1307. After resource mapping, the BS transmits the modulated NB-PBCH signals at operation 1309.

Referring to FIG. 13B, a UE first achieves synchronization and obtains NB-PBCH TTI boundary at operation 1311. In the subframes allocated for NB-PBCH transmission, the UE extracts the NB-RSs from the corresponding REs at operation 1313. Meanwhile, the UE extracts the data symbols from the REs excluding the first m (e.g., m=3) OFDM symbols, and the REs allocated to LTE CRSs (up to 4 antenna ports assuming in-band operation) and NB-RSs (up to 2 antenna ports assuming maximum antenna usage case) at operation 1315. Then, the UE makes channel estimation and NB-PBCH demodulation at operation 1317, and finally obtain NB-PBCH payload and an operation mode at operation 1319.

### Embodiment 2

The NB-PBCH utilizes the resource elements in the n-th subframe, except the first m OFDM symbols. For in-band mode, the legacy LTE CRS resource elements are counted in the mapping process but the NB-PBCH symbols are not transmitted, while reserved for transmissions of LTE CRS symbols. That means the LTE CRS symbols puncture the NB-PBCH symbols in the corresponding CRS resource elements. For guard-band and standalone modes, no puncturing operation is applied.

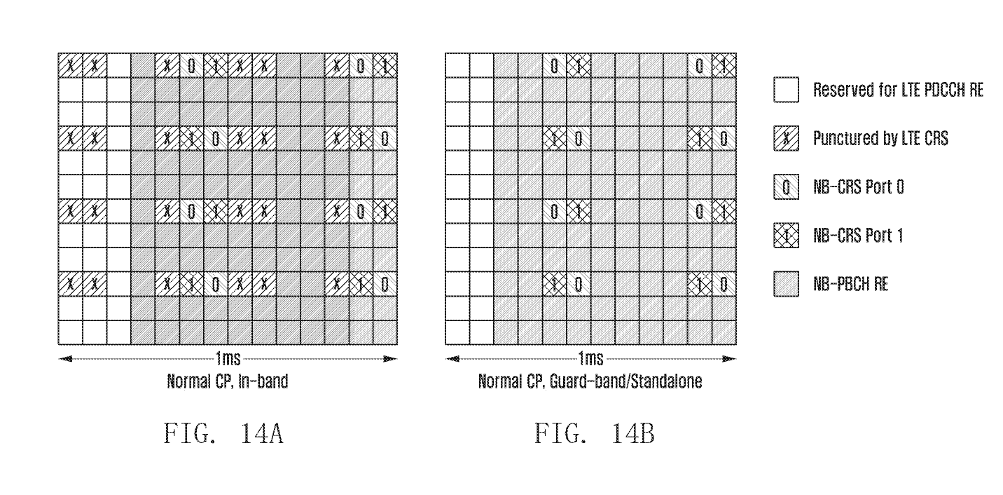

FIGS. 14A and 14B show an example to illustrate the difference of NB-PBCH resource mapping in different modes according to an embodiment of the present disclosure.

### Resource Mapping Procedure in Embodiment 2

Here the resource mapping procedure of NB-PBCH in Embodiment 2 is described, assuming that the NB-PBCH TTI is 640 ms within which 64 subframes are allocated to NB-PBCH.

The block of bits b(0), . . . , b(M_{bit}−1), where M_{bit} is the number of bits transmitted on the NB-PBCH, are scrambled with a cell-specific sequence prior to modulation, resulting in a block of scrambled bits \tilde{b}(0), . . . , \tilde{b}(M_{bit}−1) according to

\tilde{b}(i)=(b(i)+c(i))mod 2

where the scrambling sequence c(i) is given by clause 7.2 of 3GPP TS 36.211. The scrambling sequence may be initialized with cᵢₙᵢₜ=N_{ID}^{Cell,NB-IoT} in each radio frame fulfilling n_{f} mod 64=0.

The block of scrambled bits \tilde{b}(0), . . . , \tilde{b}(M_{bit}−1) are modulated as described in clause 7.1 of 3GPP TS 36.211, resulting in a block of complex-valued modulation symbols d(0), . . . , d(M_{symb}−1).

The block of modulation symbols d(0), . . . , d(M_{symb}−1) are mapped to layers according to one of clauses 6.3.3.1 or 6.3.3.3 of 3GPP TS 36.211 with M_{symb}⁽⁰⁾=M_{symb} and precoded according to one of clauses 6.3.4.1 or 6.3.4.3 of 3GPP TS 36.211, resulting in a block of vectors y(i)=[y⁽⁰⁾(i) . . . y^{(P-1)}(i)]^{T}, i=0, . . . , M_{symb}−1, where y^{(p)}(i) represents the signal for antenna port p and where p=0, . . . , P−1 and the number of antenna ports for CRSs Pε{1,2,4}. Here the NB-IoT may only support up to 2 antenna ports.

The block of complex-valued symbols y^{(p)}(0), . . . , y^{(p)}(M_{symb}−1) for each antenna port is transmitted during 64 consecutive radio frames starting in each radio frame fulfilling n_{f} mod 64=0 and are mapped in sequence starting with y(0) to resource elements (k, l). For all operation modes, the symbols are mapped to resource elements (k, l) not reserved for transmission of NB-RSs. The mapping to resource elements (k, l) is in increasing order of first the index k, then the index l in in the OFDM symbols (except the first m OFDM symbols) in subframe n and finally the radio frame number. In each subframe, the resource element indices are given by

$$k = 0 , … , 11 , \\ l = \{ \begin{matrix}m , m + 1 , … 6 & slot 0 , for normal CP case \\ 0 , 1 , … , 6 & slot 1 , for normal CP case \\ m , m + 1 , … , 5 & slot 0 , for extended CP case \\ 0 , 1 , … , 5 & slot 1 , for extended CP case\end{matrix}$$

where the resource elements reserved for NB-RSs shall be excluded. For in-band operation, the LTE CRS resource elements within the subframe are counted in the mapping process but not transmitted, i.e., reserved for transmissions of LTE CRS symbols. That means that the CRS symbols puncture the NB-PBCH symbols in the corresponding CRS resource elements.

The mapping operation may assume the NB-RSs with maximum number of supported antenna ports being present irrespective of the actual operation and configuration.

The UEs assume that the resource elements assumed to be reserved for reference signals in the mapping operation above but not used for transmission of reference signal are not available for NB-PDSCH transmission. The UE may not make any other assumptions about these resource elements.

### BS and UE's Behaviors

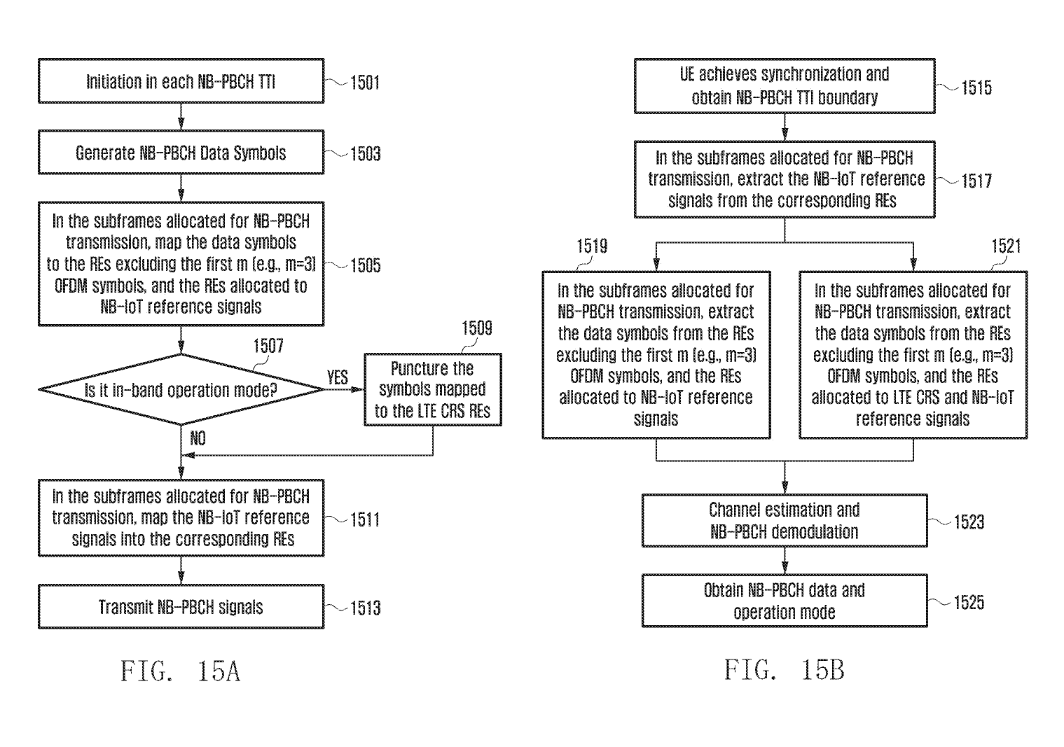

FIGS. 15A and 15B are flowcharts of BS and UE's behaviors in NB-PBCH design according to Embodiment 2 of the present disclosure.

FIG. 15A illustrates NB-PBCH transmission at the BS side, and FIG. 15B illustrates NB-PBCH reception at the UE side. Since the operation mode is not available in Embodiment 2, it is up to UE implementation to extract the LTE CRS REs or not in the NB-PBCH decoding process.

Referring to FIG. 15A, a BS performs initiation in each NB-PBCH TTI at operation 1501 and generates NB-PBCH payload and data symbols in each NB-PBCH TTI at operation 1503. In the subframes allocated for NB-PBCH transmission, the BS maps the data symbols to the REs excluding the first m (e.g., m=3) OFDM symbols, and the REs allocated to NB-RSs (up to 2 antenna ports assuming maximum antenna usage case) at operation 1505. If the NB-IoT system is operated with in-band mode at operation 1507, the LTE CRS symbols puncture the mapped NB-PBCH symbols in the corresponding CRS REs at operation 1509. Then, in the subframes allocated for NB-PBCH transmission, the BS maps the NB-RSs into the corresponding REs at operation 1511. After resource mapping, the BS transmits the modulated NB-PBCH signals at operation 1513.

Referring to FIG. 15B, a UE first achieves synchronization and obtains NB-PBCH TTI boundary at operation 1515. In the subframes allocated for NB-PBCH transmission, the UE extracts the NB-RSs from the corresponding REs at operation 1517. Meanwhile, the UE extracts the data symbols from the REs excluding the first m (e.g., m=3) OFDM symbols and NB-RSs (up to 2 antenna ports assuming maximum antenna usage case) at operation 1519 and 1521. It is up to UE implementation to exclude the REs allocated to LTE CRS (up to 4 antenna ports assuming in-band operation) or not, depending on the various situations. Then, the UE makes channel estimation and NB-PBCH demodulation at operation 1523, and finally obtains NB-PBCH payload and an operation mode at operation 1525.

In the step of NB-PBCH RE extraction, before being connected to the network, it is up to UE implementation to exclude the REs allocated to LTE CRS (up to 4 antenna ports assuming in-band operation) or not. After being connected to network and obtaining the operation mode, the UE can decide the proper operation based on the current operation mode, e.g., exclude the REs allocated to LTE CRS for in-band operation case, otherwise not for standalone and guard-band operation cases.

### Embodiment 3

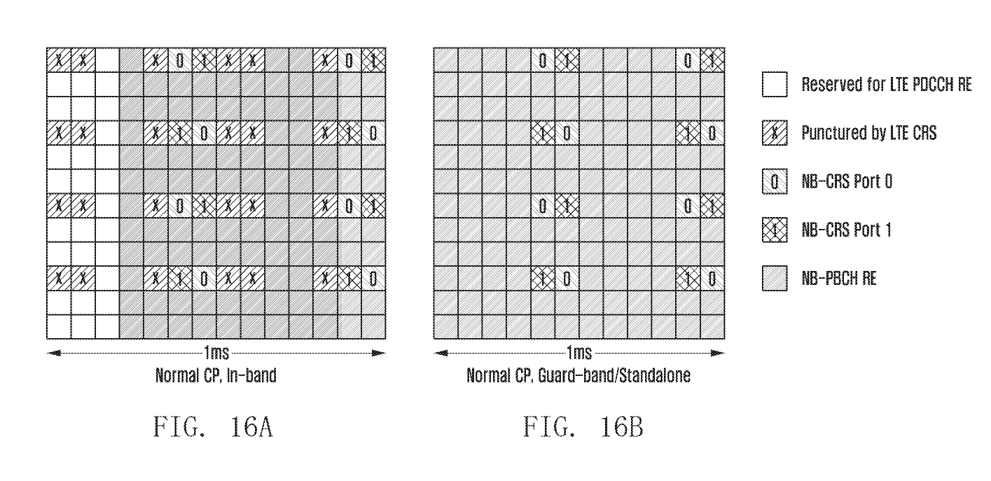

FIGS. 16A and 16B show a third example of NB-PBCH design according to an embodiment of the present disclosure.

Referring to FIGS. 16A and 16B, an example is illustrated to show the difference of NB-PBCH resource mapping in different modes. If the operation mode can be differentiated via synchronization, there is no need to reserve the first m OFDM symbols in guard-band and standalone modes. Thus, all the OFDM symbols can be utilized for NB-PBCH transmission in the guard-band and standalone modes. For in-band mode, the first m OFDM symbols are not utilized, and the legacy LTE CRS resource elements are reserved as in Embodiment 1, or puncture the NB-PBCH symbols as in Embodiment 2.

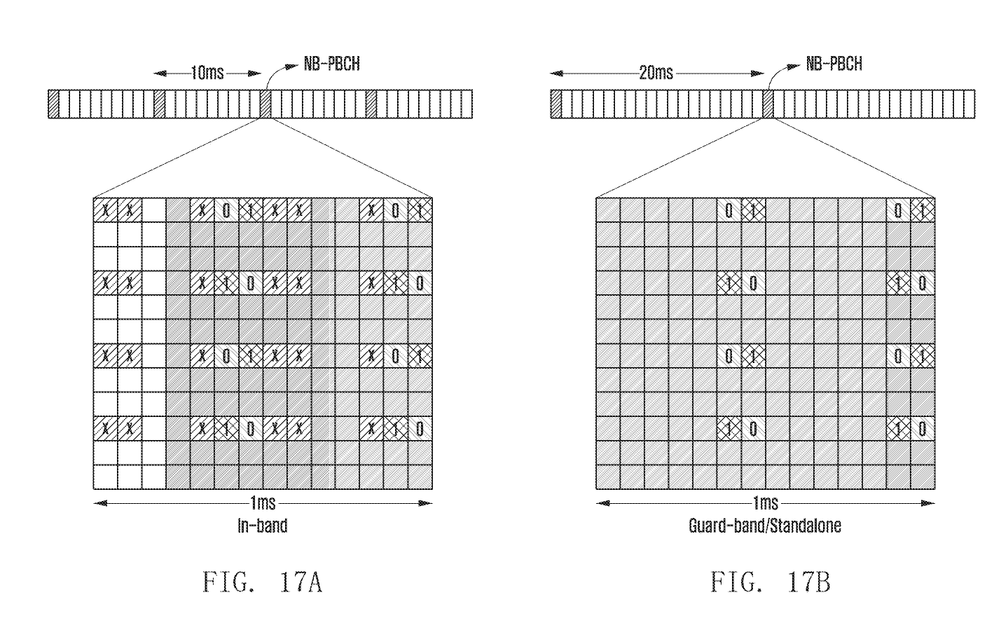

FIGS. 17A and 17B show an example of different NB-PBCH periodicities for different operation modes according to an embodiment of the present disclosure. Since the amount of available resource elements per subframe is different, different periodicities of NB-PBCH subframes can be defined for different modes, as shown in the example of FIGS. 17A and 17B.

### Resource Mapping Procedure in Embodiment 3

For in-band operation, the resource mapping procedure in Embodiment 3 can be same as those in Embodiment 1 and Embodiment 2. Note that the difference between the in-band mapping procedures in Embodiment 1 and Embodiment 2 is whether the legacy LTE CRS resource elements are counted in the resource mapping process or not.

For guard-band or standalone operation, the resource mapping procedure in Embodiment 3 is similar as that in Embodiment 2, but all the symbols within the subframe are considered for resource mapping. The mapping to resource elements (k, l) is in increasing order of first the index k, then the index l in in the OFDM symbols in subframe n and finally the radio frame number. In each subframe, the resource element indices are given by

$$k = 0 , … , 11 , \\ l = \{ \begin{matrix}0 , 1 , … , 6 & slot 0 and 1 , for normal CP case \\ 0 , 1 , … , 5 & slot 0 and 1 , for extended CP case\end{matrix}$$

where the resource elements reserved for NB-RSs are excluded.

### BS and UE's Behaviors

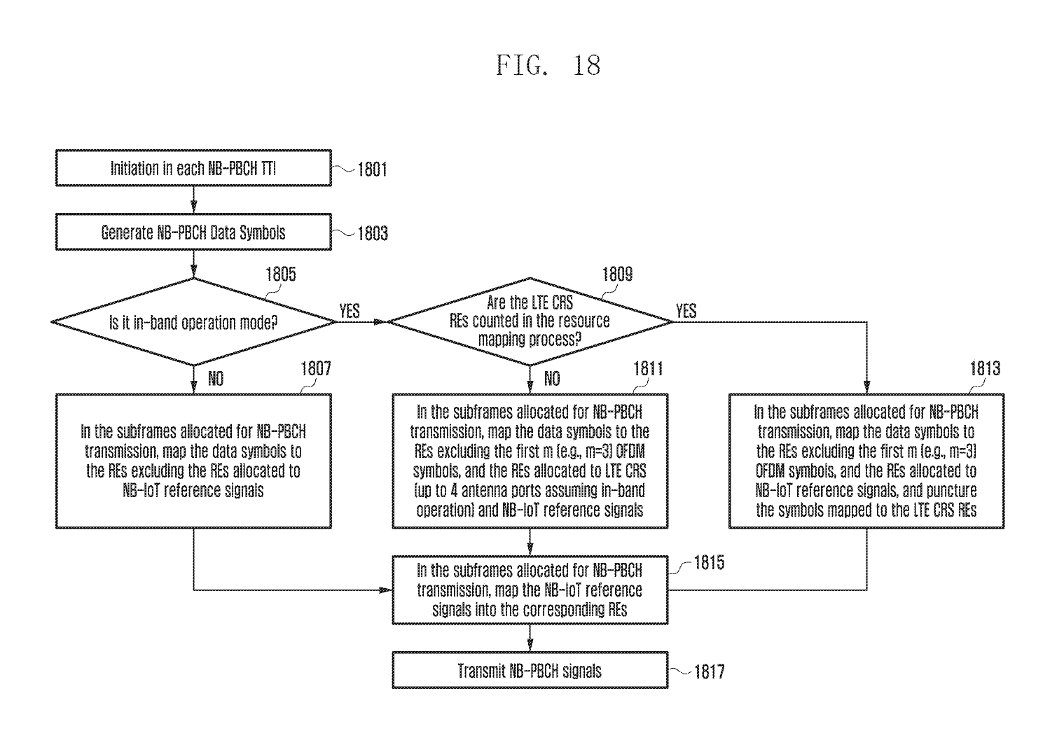

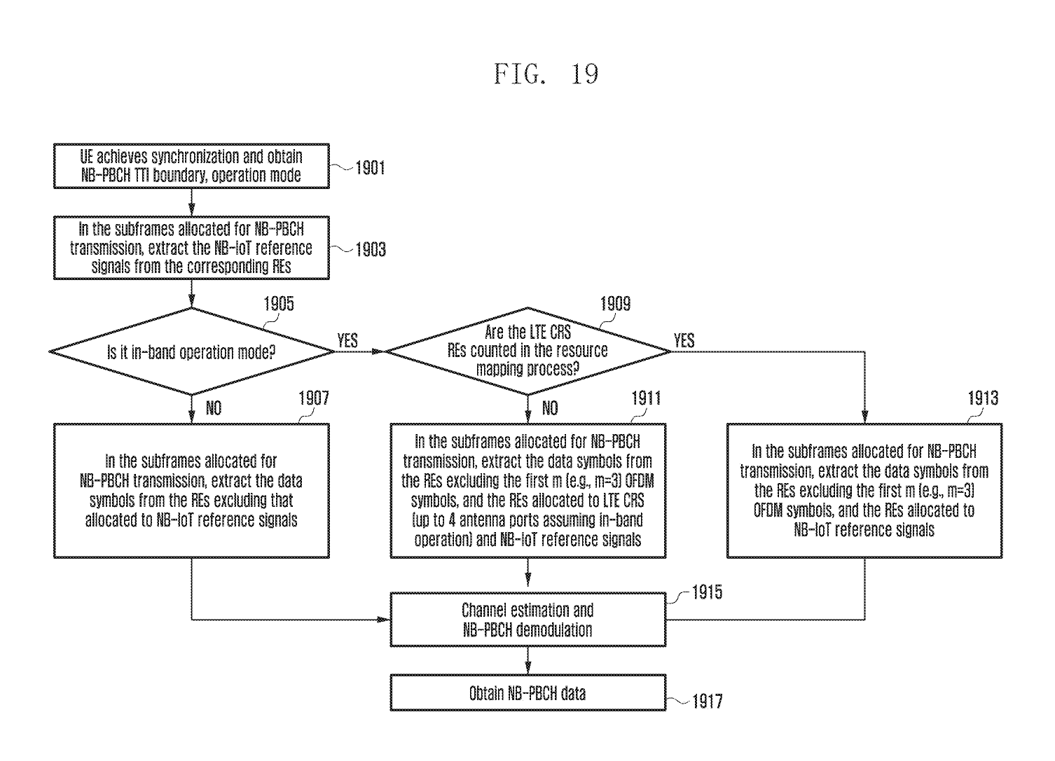

FIGS. 18 and 19 are the flowcharts of BS and UE's behaviors in NB-PBCH design according to Embodiment 3 of the present disclosure.

FIG. 18 illustrates NB-PBCH transmission at the BS side, and FIG. 19 illustrates NB-PBCH reception at the UE side.

Referring to FIG. 18, a BS performs initiation in each NB-PBCH TTI at operation 1801 and generates NB-PBCH payload and data symbols in each NB-PBCH TTI at operation 1803. In the subframes allocated for NB-PBCH transmission, the BS maps the data symbols to the REs depending on the operation mode at operation 1805. If it is not in-band operation mode, the BS maps the data symbols to the REs excluding the REs allocated to NB-RSs (up to 2 antenna ports assuming maximum antenna usage case) at operation 1807. If it is in-band operation mode, the RE mapping may depend on the pre-defined rule. If the LTE CRS REs are not counted in the resource mapping process at operation 1809, the BS maps the data symbols to the REs excluding the first m (e.g., m=3) OFDM symbols and NB-RSs (up to 2 antenna ports assuming maximum antenna usage case), as well as the REs allocated to LTE CRS (up to 4 antenna ports assuming in-band operation) at operation 1811. If the LTE CRS REs are counted in the resource mapping process, the BS maps the data symbols to the REs excluding the first m (e.g., m=3) OFDM symbols and NB-RSs (up to 2 antenna ports assuming maximum antenna usage case), and the LTE CRS symbols puncture the mapped NB-PBCH symbols in the corresponding CRS REs at operation 1813. Then, in the subframes allocated for NB-PBCH transmission, the BS maps the NB-RSs into the corresponding REs at operation 1815. After resource mapping, the BS transmits the modulated NB-PBCH signals at operation 1817.

Referring to FIG. 19, a UE first achieves synchronization and obtain NB-PBCH TTI boundary and operation mode information at operation 1901. In the subframes allocated for NB-PBCH transmission, UE extracts the NB-RSs from the corresponding REs at operation 1903. Meanwhile, the UE extracts the data symbols based on the operation mode information. If it is not in-band operation mode at operation 1905, the UE extracts the data symbols from the REs excluding the REs allocated to NB-RSs (up to 2 antenna ports assuming maximum antenna usage case) at operation 1907. If it is in-band operation, the RE extraction may depend on whether the LTE CRS REs are counted in the NB-PBCH resource mapping or not. If the LTE CRS REs are counted in the resource mapping process at operation 1909, the UE extracts the data symbols from the REs excluding the first m (e.g., m=3) OFDM symbols and NB-RSs (up to 2 antenna ports assuming maximum antenna usage case) at operation 1913. It is up to UE implementation to exclude the REs allocated to LTE CRS (up to 4 antenna ports assuming in-band operation) or not. If the LTE CRS REs are not counted in the resource mapping process, the UE extracts the data symbols from the REs excluding the first m (e.g., m=3) OFDM symbols and REs allocated to LTE CRS (up to 4 antenna ports assuming in-band operation) and NB-RSs (up to 2 antenna ports assuming maximum antenna usage case) at operation 1911. Then, the UE makes channel estimation and NB-PBCH demodulation at operation 1915, and finally obtain NB-PBCH payload at operation 1917.

### Embodiment 4

For in-band mode, the NB-PBCH utilizes the resource elements in the n-th subframe, except the first m OFDM symbols. However, for guard-band and standalone modes, the first m OFDM symbols can be utilized. If the UEs have no information about the operation modes, a special mapping pattern can be used to allow UEs decode NB-PBCH irrespective if the resources are mapped to the first m OFDM symbols or not.

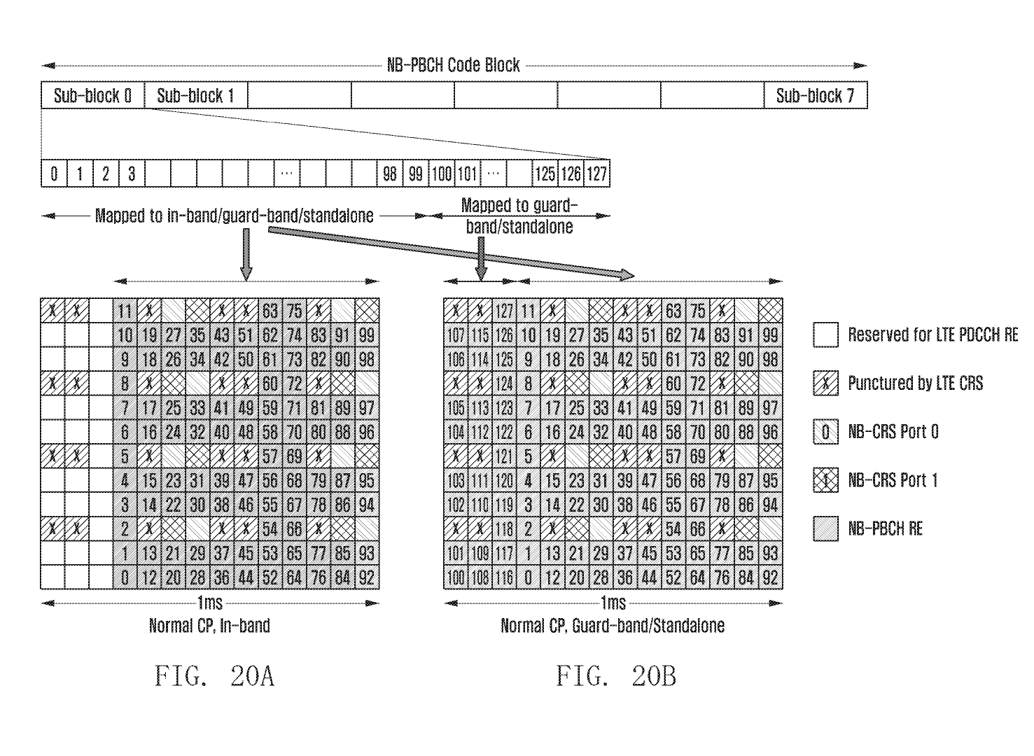

FIGS. 20A and 20B show a fourth example of NB-PBCH design according to an embodiment of the present disclosure.

Referring to FIG. 20, an example is illustrated to show that different NB-PBCH resource mapping in different modes. The NB-PBCH code block is constructed considering the available resource elements in the standalone case, i.e., all the resource elements expect the LTE-CRS REs and NB-IoT CRS REs are available during one subframe. For all operation modes, the resource mapping starts from the m-th OFDM symbol in a subframe. For in-band operation, the resource mapping stops at the last symbol in a subframe. For guard-band and standalone operation, the resource mapping starts from the m-th OFDM symbol till to the last symbol, and then continue resource mapping in the first m OFDM symbols. In the initial NB-PBCH reception, the UEs can try to decode NB-PBCH without counting the first m OFDM symbols. After the operation mode is available, the UEs can decode the NB-PBCH based on the different resource mapping in different operation mode. In this resource mapping approach, the NB-PBCH is decodable irrespective if the first m OFDM symbols are processed in the decoding process.

### Resource Mapping Procedure in Embodiment 4

For in-band operation, the resource mapping procedure in Embodiment 4 can be same as that in Embodiment 1.

For guard-band or standalone operation, all the symbols within the subframe are considered for resource mapping. The mapping to resource elements (k, l) is in increasing order of first the index k, then a pre-defined order of index l′ in the OFDM symbols in subframe n and finally the radio frame number. The pre-defined order of index l′ can be expressed by

$${l}^{′} = \{ \begin{matrix}\begin{matrix}( m , m + 1 , … , 6 ) in slot 0 , and then ( 0 , 1 , … , 6 ) in slot 1 , \\ and then ( 0 , 1 , … , m - 1 ) in slot 0 , for normal CP case\end{matrix} \\ \begin{matrix}( m , m + 1 , … , 5 ) in slot 0 , and then ( 0 , 1 , … , 5 ) in slot 1 , \\ and then ( 0 , 1 , … , m - 1 ) in slot 0 , for extended CP case\end{matrix}\end{matrix}$$

where m is the pre-defined OFDM symbol index, e.g., m=3.

In this embodiment, it is also possible to count LTE CRS resource elements in the resource mapping process, i.e., only NB-IoT CRS REs are excluded. However, for in-band mode, the legacy LTE CRS resource elements are counted in the mapping process but the NB-PBCH symbols are not transmitted, while reserved for transmissions of LTE CRS symbols. That means the LTE CRS symbols puncture the NB-PBCH symbols in the corresponding CRS resource elements. For guard-band and standalone modes, no puncturing operation is applied.

Meanwhile, the NB-MIB may include the following contents:

1) System Frame Number: To support in-band operation, it is necessary to align the timing between LTE and NB-IoT. The LTE frame timing has a periodicity of 10240 ms. After cell search and PBCH decoding, Nb-IoT UE has found 640 ms timing. Additional 4 bits is needed to help UE obtain the remaining timing information. When considering extended discontinuous reception (DRX), it may be preferred to further extend frame cycle by using e.g., 6 additional bits.

2) System information (SI) Change Indication: To be able to quickly determine if the System Information has changed one possible option is to have indication included in MIB. This information could also be included in system information block 1 (SIB1), as in LTE.

3) SIB1 Scheduling Information: SIB1 can be scheduled without PDCCH and the scheduling parameters are indicated in MIB.

4) Mode Indication: Since three different operation modes are considered, it may be necessary to differentiate the operation modes as quickly as possible, since the succeeding processing may be different (1 bit: to indicate in-band or not, 2 bits: to indicate in-band case 1, in-band case 2, or guard-band, or standalone). For example, the in-band case 1 can be the case that LTE and NB-IoT share the same cell ID, while the in-band case 2 can be the case that LTE and NB-IoT have different cell ID.

5) CRS Information: This is needed for in-band deployment to enable NB-IoT re-uses LTE CRS. The CRS position information is known from cell search but the sequence value is not available.

6) LTE (CRS) Antenna Ports Information: This is needed for in-band deployment to inform NB-IoT UEs about the number of antenna ports used by LTE CRS. This information is necessary because the antenna ports used for LTE and NB-IoT may be different. For example, 4 antenna ports are used in LTE, but only up to 2 antenna ports are used for NB-IoT. Even though NB-IoT UEs detect the usage of 2 antenna ports in PBCH decoding, it is necessary to know the actual number antenna ports and take this into account in the resource mapping process. 2 bits can be used to indicate the number of antenna ports in LTE, e.g., 1, or 2, or 4. Alternatively, 1 bit can be used to indicate if the number of antenna ports is 4, or indicate if the number of NB-IoT antenna ports is the same as the number of LTE antenna ports.

7) FDD/TDD Mode Information: This is needed to inform NB-IoT UEs that the current mode is FDD or TDD.

Meanwhile, the NB-RS for channel estimation can be transmitted in the downlink. Considering in-band operation, the NB-RS may be located in the resource elements different from the legacy LTE CRS.

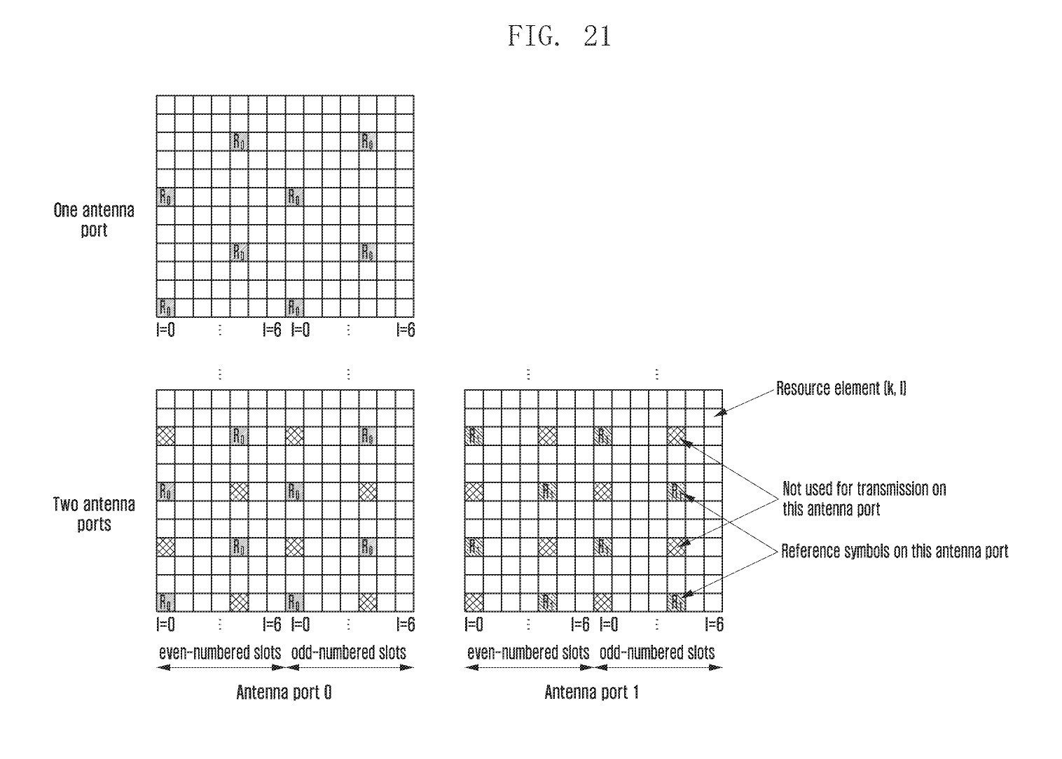

FIG. 21 illustrates an example of LTE CRS resource element mapping during one subframe, assuming that that v_{shift}=0 and normal CP case according to an embodiment of the present disclosure.

In LTE, the resource elements used for CRS transmission during one slot or subframe are a function of the cell ID on the CP case (normal CP or extended CP). The cell-specific frequency shift is given by v_{shift}=N_{ID}^{cell} mod 6, which defines the CRS position in the frequency domain. For normal CP case, the OFDM symbols 0 and 4 carry CRS when the number of antenna ports is equal or less than 2, as show in FIG. 21. For extended CP case, the OFDM symbols 0 and 3 carry CRS when the number of antenna ports is equal or less than 2.

The NB-RS design can re-use the LTE CRS design as much as possible. For example, the similar functionality of cell-specific frequency shift can be considered.

The following NB-RS resource mapping options can be considered:

### Embodiment 1

The NB-RS has a similar pattern as LTE CRS in the frequency domain, i.e., a cell-specific frequency shift is given by N_{shift}^{NB-IoT}=N_{ID}^{Cell,NB-IoT} mod 6, which define the NB-RS position in the frequency domain. In time domain, the OFDM symbols carrying NB-RS within one slot or subframe is shifted by a pre-defined offset compared to that of LTE CRS within one slot or subframe. If the index of OFDM symbols carrying NB-RS within one slot is {l₀, l₁}, the index of OFDM symbols carrying NB-RS within one slot is {(l₀+Δ₀) mod N_{syml}^{DL}, (l₁+Δ₁) mod N_{syml}^{DL}}, where Δ₀ and Δ₁ are pre-defined constant, and N_{syml}^{DL} denotes the number of OFDM symbols in one slot, i.e., 7 for normal CP case, and 6 for extended CP case.

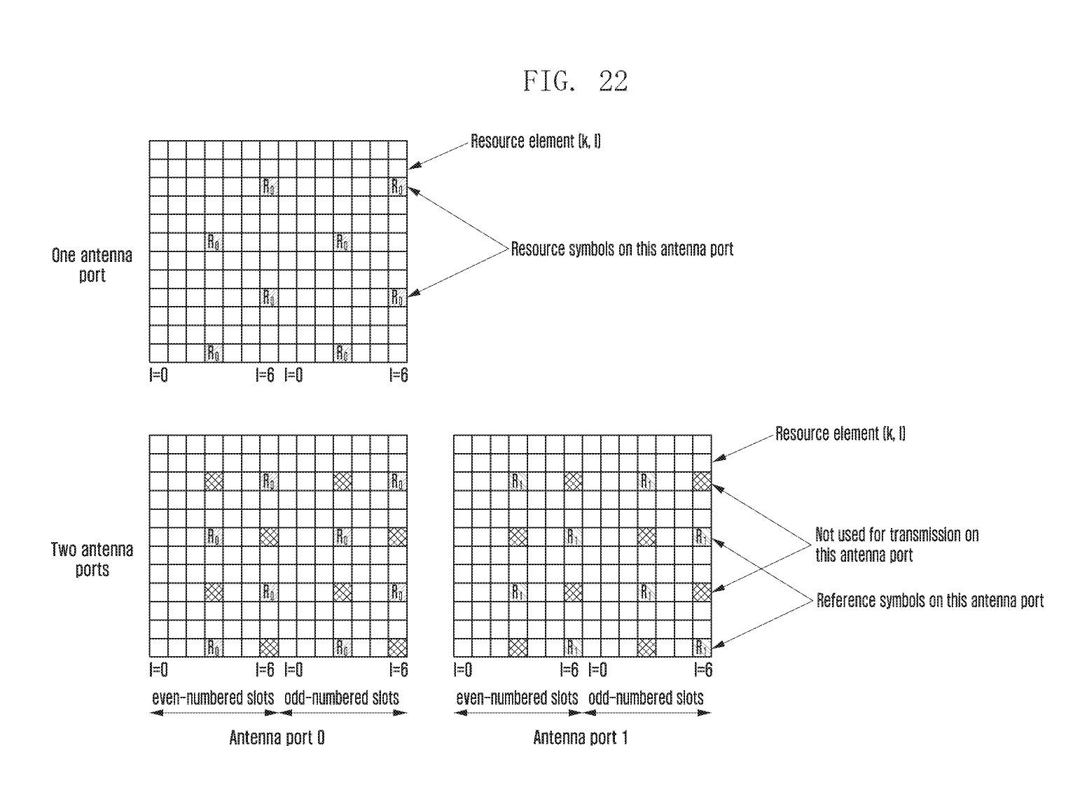

FIGS. 22, 23, 24, and 25 show examples of NB-IoT reference signals (NB-RS) patterns for normal CP according to an embodiment of the present disclosure.

### Embodiment 1-1

For example, with normal CP, the index of OFDM symbols carrying LTE CRS during one slot is {l₀=0, l₁=4}. If shifted by {Δ₀=3, Δ₁=2}, the index of OFDM symbols carrying NB-RS during one slot is {3, 6}, as shown in the example of FIG. 22.

The index of OFDM symbols carrying NB-RS are denoted by {g₀=3, g₁=6}.

The subcarrier index carrying NB-RS at the OFDM symbol l for antenna port p can be determined by the variables v_{shift}^{NB-IoT} and v, and denoted by

$${k}_{0} = ( {v}_{shift}^{NB - IoT} + v ) mod 6 , {k}_{1} = 6 + {k}_{0}$$

$$v = \{ \begin{matrix}0 & if p = 0 and l = {g}_{0} \\ 3 & if p = 0 and l = {g}_{1} \\ 3 & if p = 1 and l = {g}_{0} \\ 0 & if p = 1 and l = {g}_{1}\end{matrix}$$

### Embodiment 1-2

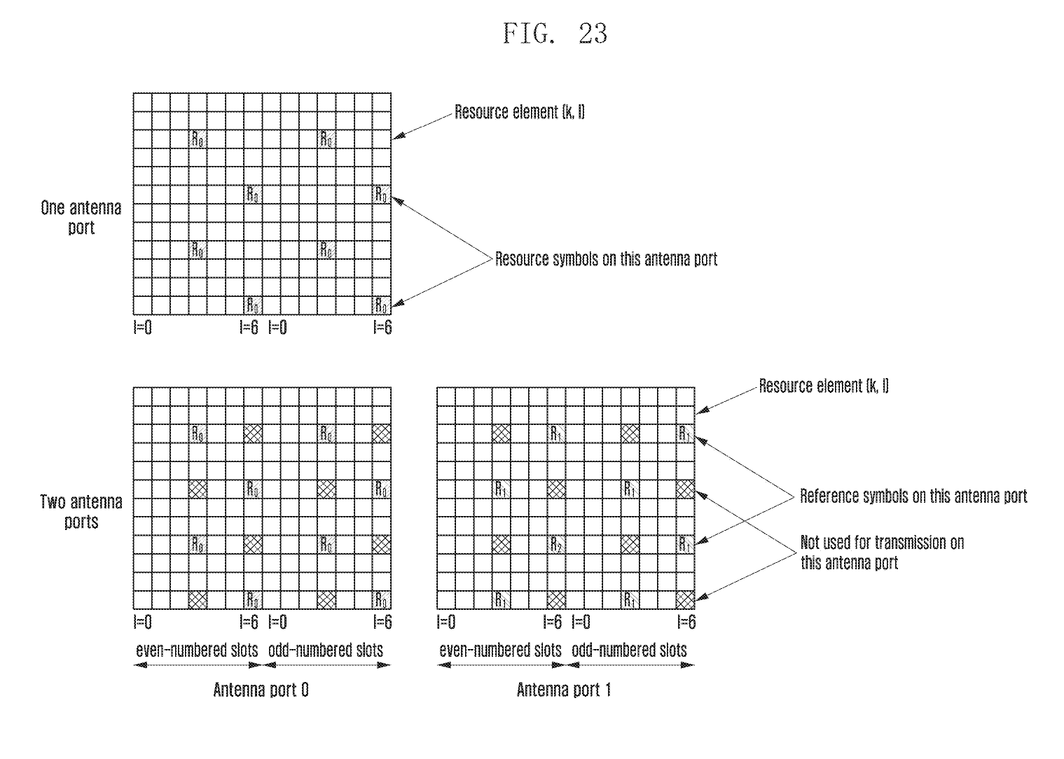

If shifted by {Δ₀=−1, Δ₁=−1} (equivalent of {Δ₀=6, Δ₁=−1}), the index of OFDM symbols carrying NB-RS during one slot is {6, 3}, as shown in the example of FIG. 23.

The index of OFDM symbols carrying NB-RS are denoted by {g₀=3, g₁=6}, since it is assumed that g₀<g₁.

The subcarrier index carrying NB-RS at the OFDM symbol l for antenna port p can be determined by the variables v_{shift} and v, and denoted by

$${k}_{0} = ( {v}_{shift}^{NB - IoT} + v ) mod 6 , {k}_{1} = 6 + {k}_{0}$$

$$v = \{ \begin{matrix}3 & if p = 0 and l = {g}_{0} \\ 0 & if p = 0 and l = {g}_{1} \\ 0 & if p = 1 and l = {g}_{0} \\ 3 & if p = 1 and l = {g}_{1}\end{matrix}$$

### Embodiment 1-3

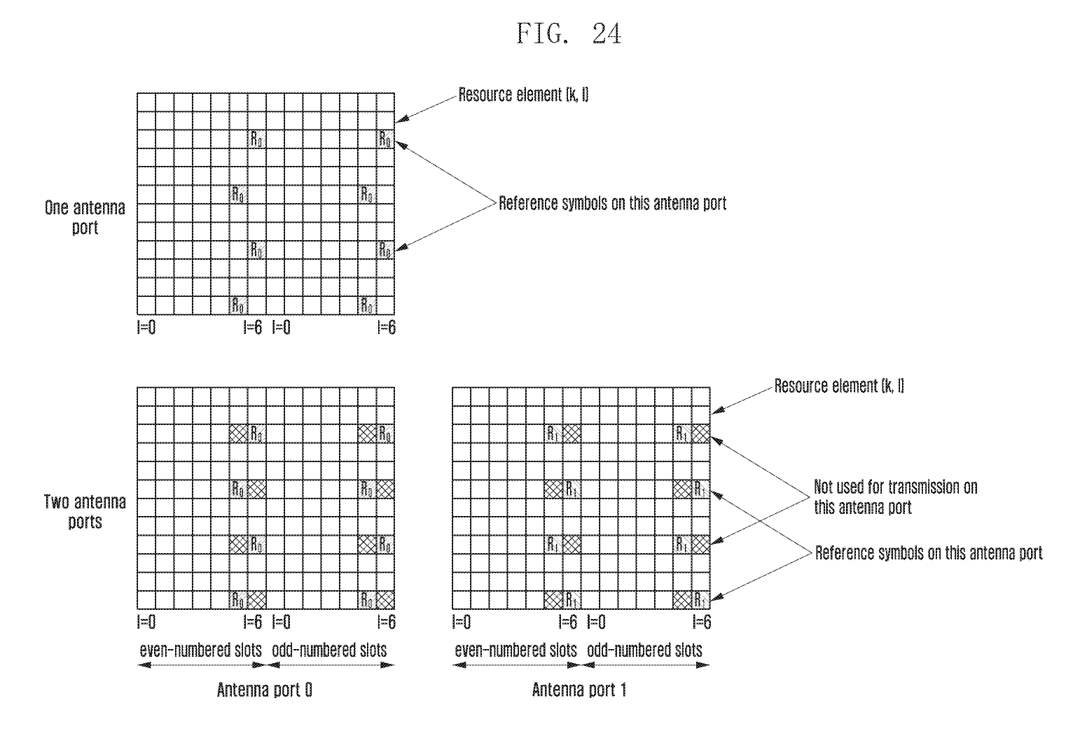

If shifted by {Δ₀=5, Δ₁=2}, the index of OFDM symbols carrying NB-RS during one slot is {5, 6}, as shown in the example of FIG. 24.

The index of OFDM symbols carrying NB-RS are denoted by {g₀=5, g₁=6}.

The subcarrier index carrying NB-RS at the OFDM symbol l for antenna port p can be determined by the variables N_{shift}^{NB-IoT} and v, and denoted by

$${k}_{0} = ( {v}_{shift}^{NB - IoT} + v ) mod 6 , {k}_{1} = 6 + {k}_{0}$$

$$v = \{ \begin{matrix}0 & if p = 0 and l = {g}_{0} \\ 3 & if p = 0 and l = {g}_{1} \\ 3 & if p = 1 and l = {g}_{0} \\ 0 & if p = 1 and l = {g}_{1}\end{matrix}$$

### Embodiment 1-4

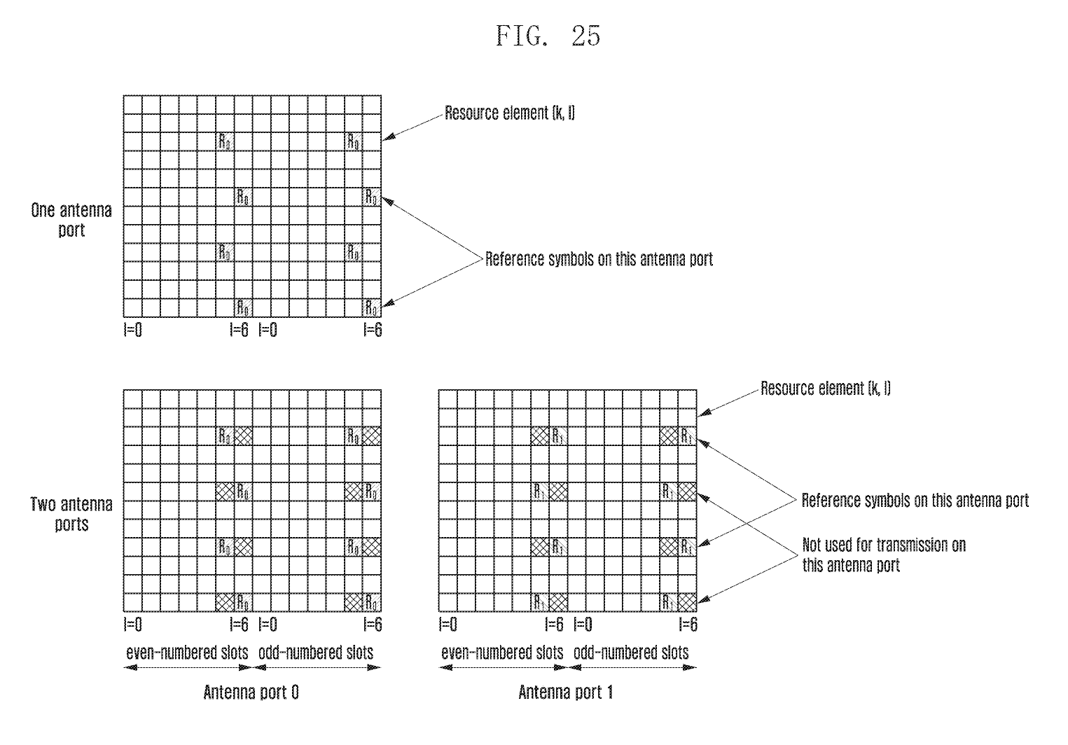

If shifted by {Δ₀=6, Δ₁=1}, the index of OFDM symbols carrying NB-RS during one slot is {6, 5}, as shown in the example of FIG. 25.

The index of OFDM symbols carrying NB-RS are denoted by {g₀=5, g₁=6}.

The subcarrier index carrying NB-RS at the OFDM symbol l for antenna port p can be determined by the variables N_{shift}^{NB-IoT} and v, and denoted by

$${k}_{0} = ( {v}_{shift}^{NB - IoT} + v ) mod 6 , {k}_{1} = 6 + {k}_{0}$$

$$v = \{ \begin{matrix}3 & if p = 0 and l = {g}_{0} \\ 0 & if p = 0 and l = {g}_{1} \\ 0 & if p = 1 and l = {g}_{0} \\ 3 & if p = 1 and l = {g}_{1}\end{matrix}$$

For extended CP case, if supported, similar approaches can be used. The corresponding NB-RS cases in the above options can be as following:

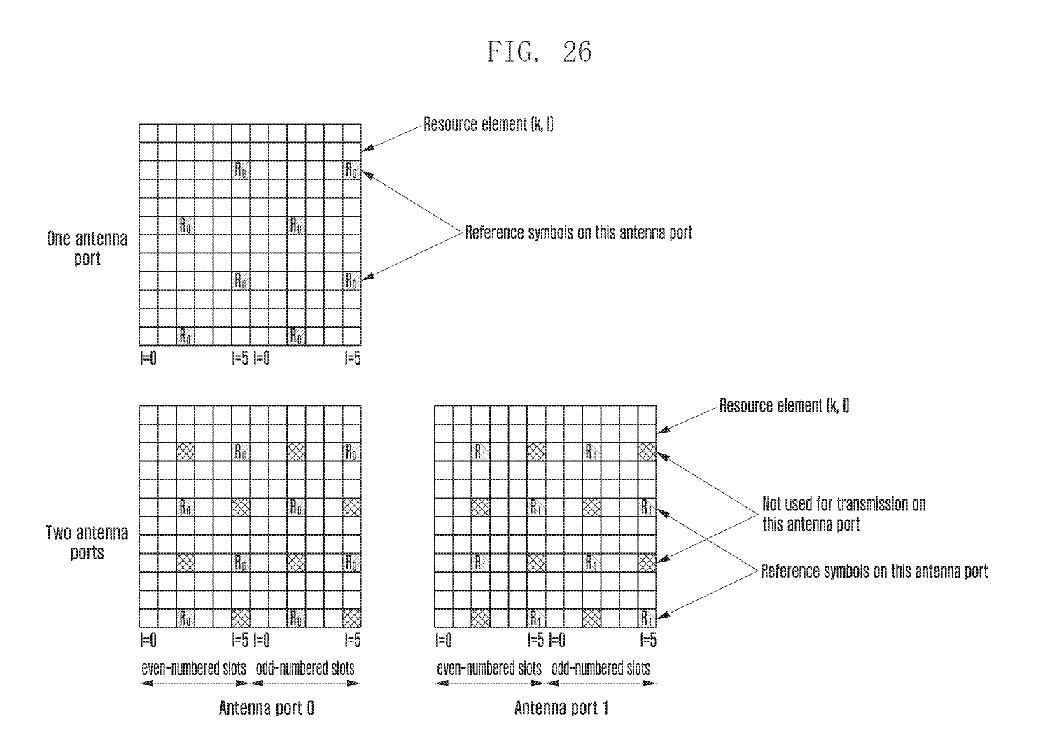

FIGS. 26, 27, 28, and 29 show examples of NB-RS patterns for extended CP according to an embodiment of the present disclosure.

### Embodiment 1-1

For extended CP, the index of OFDM symbols carrying LTE CRS during one slot is {l₀=0, l₁=3}. If shifted by {Δ₀=2, Δ₁=2}, the index of OFDM symbols carrying NB-RS during one slot is {2, 5}, as shown in the example of FIG. 26. The index of OFDM symbols carrying NB-RS are denoted by {g₀=2, g₁=5}.

### Embodiment 1-2

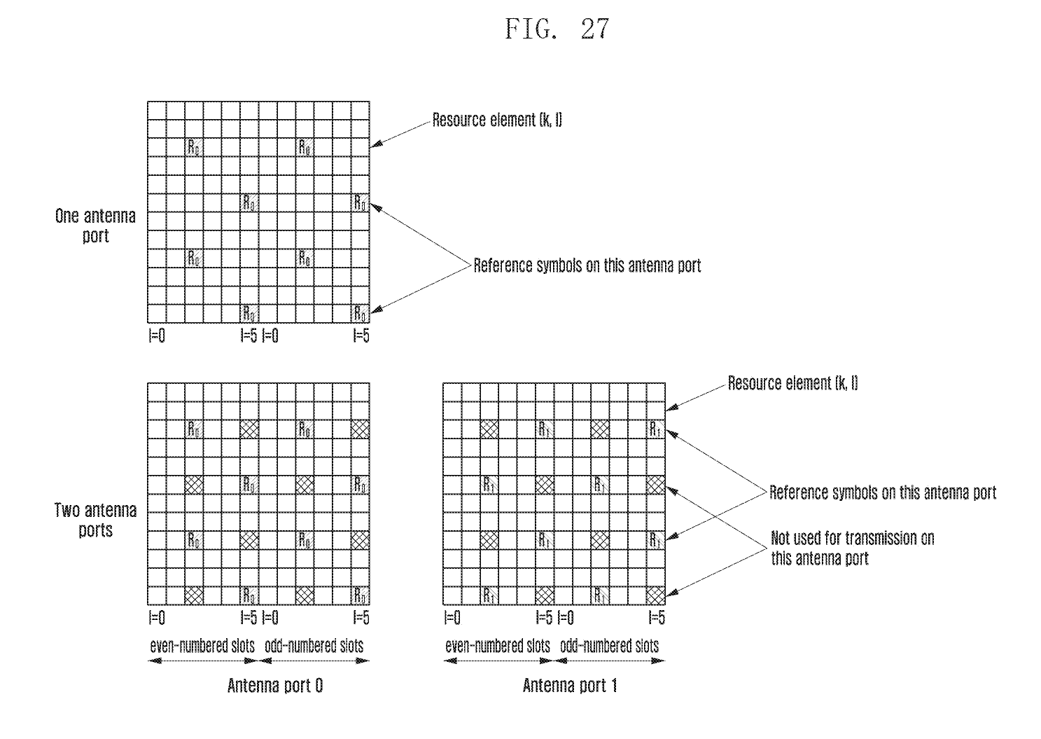

If shifted by {Δ₀=−1, Δ₁=−1} (equivalent of {Δ₀=5, Δ₁=−1}), the index of OFDM symbols carrying NB-RS during one slot is {5, 2}, as shown in the example of FIG. 27. The index of OFDM symbols carrying NB-RS are denoted by {g₀=2, g₁=5}.

### Embodiment 1-3

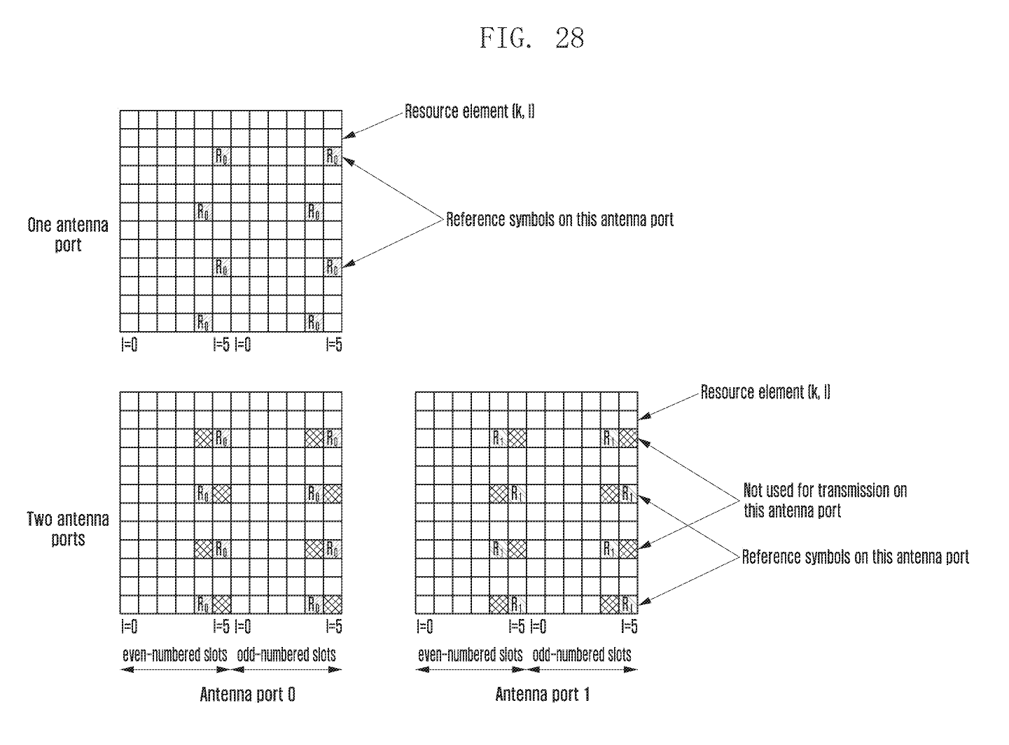

If shifted by {Δ₀=4, Δ₁=2}, the index of OFDM symbols carrying NB-RS during one slot is {4, 5}, as shown in the example of FIG. 28. The index of OFDM symbols carrying NB-RS are denoted by {g₀=4, g₁=5}.

### Embodiment 1-4

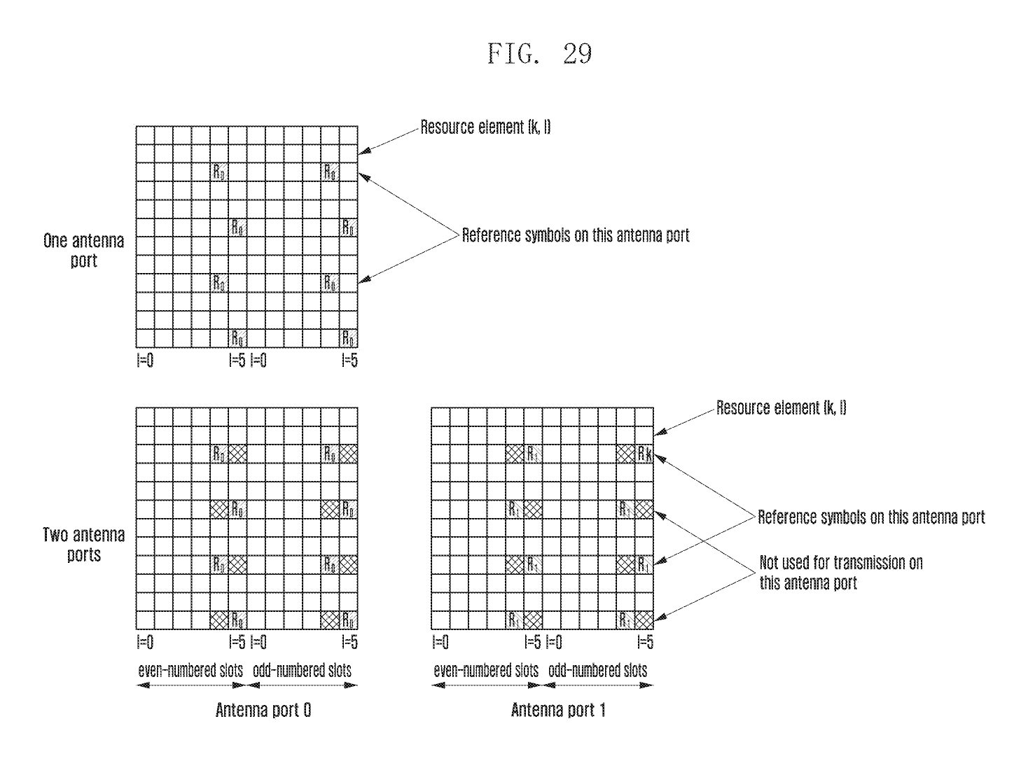

If shifted by {Δ₀=5, Δ₁=1}, the index of OFDM symbols carrying NB-RS during one slot is {5, 4}, as shown in the example of FIG. 29. The index of OFDM symbols carrying NB-RS are denoted by {g₀=4, g₁=5}.

The above-described embodiments abasically consider that the difference between the index of OFDM symbols carrying NB-RS during one slot for normal CP case and extended CP case is 1, i.e., {g_{0,Extended}_{_}_{CP}=g_{0,Nomal}_{_}_{CP}−1, g_{1,Extended}_{_}_{CP}=g_{1,Nomal}_{_}_{CP}−1}. However, there is no need of keeping the above conditions

In addition, the above-described embodiments can be combined in different ways. For example, with normal CP, the index of OFDM symbols carrying NB-RS during one slot is {3, 6}, as shown in the example of FIG. 22. For extended CP case, the index of OFDM symbols carrying NB-RS during one slot is {4, 5}, as shown in the example of FIG. 28. The above combination can be defined for the NB-IoT system.

Other parameters are also possible, under the condition that the index of OFDM symbols carrying NB-RS are located within the within slot, and not overlap with the index of OFDM symbols carrying LTE CRS, and the OFDM symbols carrying NB-RS does not overlap. In summary, assuming that index of OFDM symbols carrying NB-RS during one slot is denoted by {g₀, g₁} and g₀<g₁, the subcarrier index carrying NB-RS at the OFDM symbol l for antenna port p can be determined by the variables N_{shift}^{NB-IoT} and v, and denoted by

$${k}_{0} = ( {v}_{shift}^{NB - IoT} + v ) mod 6 , {k}_{1} = 6 + {k}_{0}$$

$$v = \{ \begin{matrix}0 & if p = 0 and l = {g}_{0} \\ 3 & if p = 0 and l = {g}_{1} \\ 3 & if p = 1 and l = {g}_{0} \\ 0 & if p = 1 and l = {g}_{1}\end{matrix}$$

Alternatively, the subcarrier index carrying NB-RS at the OFDM symbol for antenna port p can be determined by the variables N_{shift}^{NB-IoT} and v, and denoted by

$${k}_{0} = ( {v}_{shift}^{NB - IoT} + v ) mod 6 , {k}_{1} = 6 + {k}_{0}$$

$$v = \{ \begin{matrix}3 & if p = 0 and l = {g}_{0} \\ 0 & if p = 0 and l = {g}_{1} \\ 0 & if p = 1 and l = {g}_{0} \\ 3 & if p = 1 and l = {g}_{1}\end{matrix}$$

Either solution above can be used as default NB-RS resource mapping for NB-IoT downlink in all operation modes.

### Embodiment 2

The NB-RS are located in the same OFDM symbols as that for LTE CRS. In the frequency domain, different cell-specific frequency shift is used, e.g., given by v_{shift}^{NB-IoT}=(N_{ID}^{cell,NB-IoT}+Δ) mod 6, where Δ is a pre-defined integer offset to avoid that the LTE CRS and NB-RS occupy the same subcarrier in the same OFDM symbol. For example, Δ can be equal to 1 or 2, and other values are also possible as long as there is no overlap between LTE CRS and NB-RS in in-band operation. The subcarrier index carrying NB-RS at the OFDM symbol l for antenna port p can be determined by the variables v_{shift}^{NB-IoT} and v in a similar manner as discussed above.

### Embodiment 3

The option combines Embodiment 1 and Embodiment 2 to make design option. NB-RS has a similar pattern as LTE CRS in the frequency domain, i.e., the cell-specific frequency shift is given by v_{shift}^{NB-IoT} or =(N_{ID}^{cell,NB-IoT}+Δ) mod 6, which define the NB-RS position in the frequency domain, and Δ is a pre-defined integer offset (e.g., Δ can be equal to 1 or 2). In time domain, the OFDM symbols carrying NB-RS within one slot or subframe is shifted by a pre-defined offset compared to that of LTE CRS within one slot or subframe. If the index of OFDM symbols carrying NB-RS within one slot is {l₀, l₁}, the index of OFDM symbols carrying NB-RS within one slot is {l₀+Δ₀, l₁+Δ}, where Δ₀ and Δ₁ are pre-defined constant. The subcarrier index carrying NB-RS at the OFDM symbol l for antenna port p can be determined by the variables v_{shift}^{NB-IoT} and v in a similar manner as discussed above.

The NB-RS sequence generation can re-use the functionalities of LTE CRS sequence generation described in clause 6.10.1 of TS 36.211.

The NB-RS sequence is generation based on a reference-signal sequence r_{l,n}_{ₛ}(m), which is defined by

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 2 {N}_{RB}^{max , DL} - 1$$

where nₛ is the slot number within a radio frame and l is the OFDM symbol number within the slot. N_{RB}^{max,DL} is the maximum number of RBs in LTE system bandwidth, i.e., 20 MHz case. The pseudo-random sequence c(i) is defined in clause 7.2 of TS 36.211. The pseudo-random sequence generator is initialized with

cᵢₙᵢₜ=2¹⁰·(7·(nₛ+1)+l+1)·(2·N_{ID}^{Cell,NB-IoT}+1)+2·N_{ID}^{Cell,NB-IoT}+N_{CP}

at the start of each OFDM symbol where

$${N}_{CP} = \{ \begin{matrix}1 & for normal CP \\ 0 & for extended CP\end{matrix} .$$

The N_{ID}^{Cell,NB-IoT} is the PCID of the NB-IoT cell. It is also possible that some parameters can be fixed.

Within one PRB, a section of the reference signal sequence r_{l,n}_{ₛ}(m) is mapped to complex-valued modulation symbols a_{k,l}^{(p)} used as reference symbols for antenna port p in slot nₛ according to

a_{k,l}^{(p)}=r_{l,n}_{ₛ}(m′)

where

k=6 m+(v_{shift}^{NB-IoT}+v)mod 6,

l=g₀, g₁, i.e., the OFDM symbol index carrying NB-RS in one slot

m=0,1

m′=m+N_{RB}^{max,DL}−M

where m is a fixed integer offset to determine which section of the reference signal sequence r_{l,n}_{ₛ}(m) is used for NB-RS. To match the bandwidth case as in LTE, M=1, which means the sequences r_{l,n}_{ₛ}(N_{RB}^{max,DL}−1), r_{l,n}_{ₛ}(N_{RB}^{max,DL}) are mapped to the NB-RS symbols aₖ_{₀}_{,l}^{(p)} and aₖ_{₁}_{,l}^{(p)} for antenna port p in slot nₛ where k₀=(v_{shift}^{NB-IoT}+v)mod 6, k₁=k₀+6. Other values can also be used for M.

Resource elements (k,l) used for transmission of NB-RS on any of the antenna ports in a slot shall not be used for any transmission on any other antenna port in the same slot and set to zero.

### PBCH Resource Utilization in Reserved OFDM Symbols

In the NB-PBCH resource mapping embodiments above, the first m (e.g., m=3) OFDM symbols of the subframes allocated to NB-PBCH are reserved in guard-band and standalone modes if the operation mode information is not available to the UEs when receiving NB-PBCH. Similarly, the first m (e.g., m=3) OFDM symbols of the subframes allocated to NB-PSS/SSS may be also reserved in guard-band and standalone modes because the operation mode information is not available.

To optimize the resource utilization, these reserved OFDM symbols can be further utilized in several options:

### Embodiment 1

These OFDM symbols can be used for NB-PDCCH and/or NB-PDSCH.

These OFDM symbols can be counted in the resource mapping process of NB-PDCCH and/or NB-PDSCH mapping.

### Embodiment 2

These OFDM symbols can carry some repetition of other channels or signals.

These OFDM symbols can be utilized to transmit the additional repetition of some NB-IoT signals, e.g., NB-PSS/SSS. This can reduce the cell search time in the access process. Similarly, the repetition of NB-PBCH can also be transmitted, to reduce the time of obtaining NB-MIB information.

### Embodiment 3

These OFDM symbols can be considered for carry additional signaling.

In guard-band and standalone modes, the first m OFDM symbols can be utilized to carry additional information of the system or cell. For example, a pre-defined sequence can be transmitted to indicate that the current operation mode is not in-band mode, since the first m OFDM symbols are reserved for legacy LTE PDCCH/PCFICH/PHICH. It is also possible to utilize these symbols to send a pre-defined message with some system parameters, e.g., SIB1, or paging indication, and so on.

Alternatively, the first m OFDM symbols can be utilized to carry additional reference signals for CSI measurement or RSRP measurement at the UE side. Due to the narrow bandwidth of NB-IoT, more reference signals are preferred to improve the accuracy of channel estimation and RSRP measurement.

The activation or de-activation of the usage of first m OFDM symbols can be indicated in the system information.

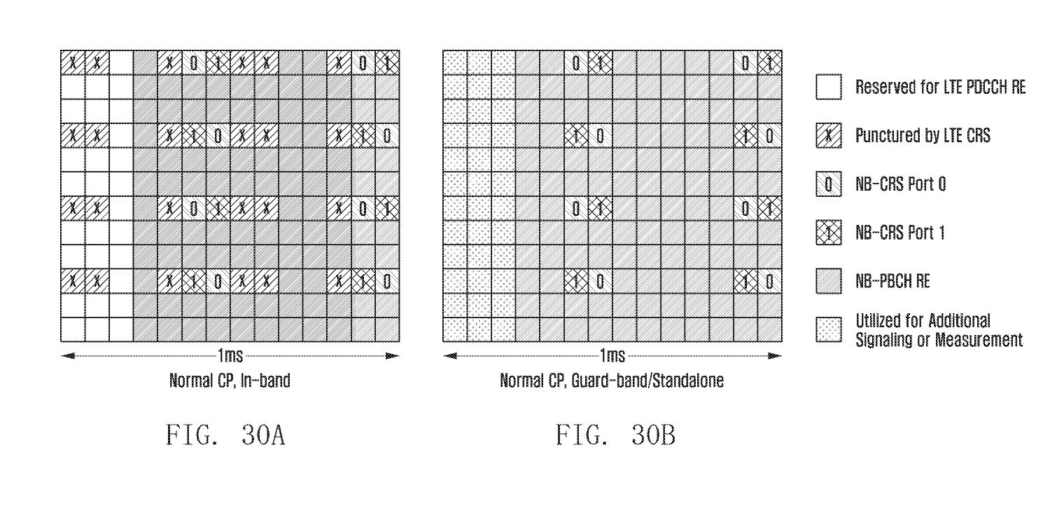

FIGS. 30A and 30B show an example of utilizing the first m OFDM symbols (e.g., m=3) in NB-PBCH subframes in guard-band/standalone operation modes according to an embodiment of the present disclosure.

Referring to FIGS. 30A and 30B, the first m OFDM symbols can be utilized to carry additional information in NB-PBCH subframes in guard-band and standalone operation modes.

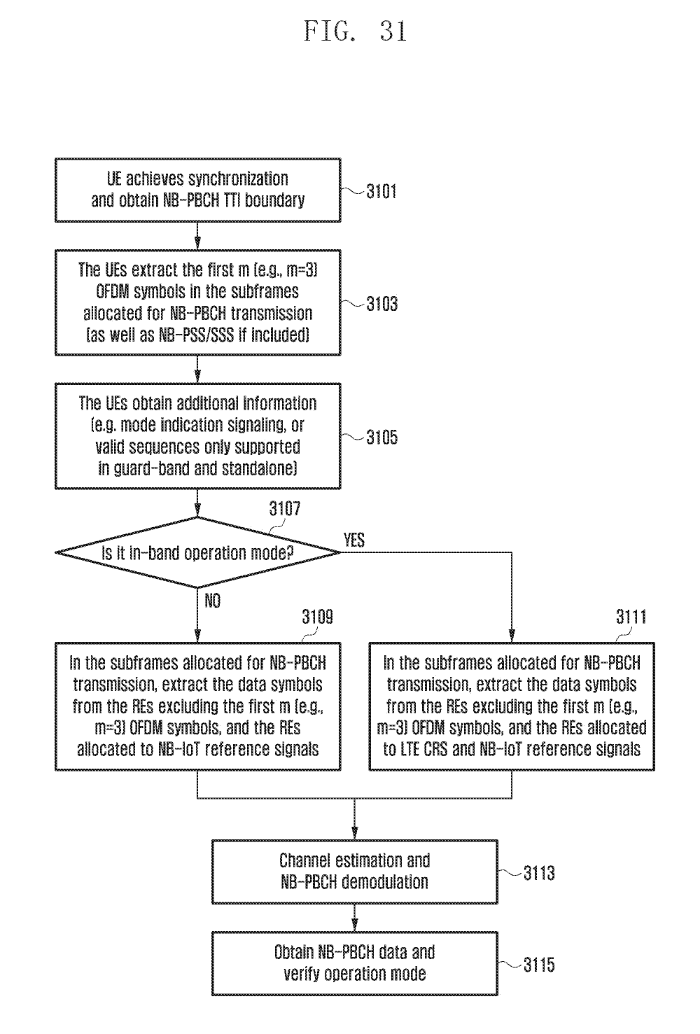

FIG. 31 is the flowchart of the UE's behavior in NB-PBCH reception with assisted signaling information according to an embodiment of the present disclosure.

Referring to FIG. 31, the UE's behavior can be differentiated if the UE obtains the additional information carried in the first m OFDM symbols, e.g., in Embodiment 2 for the NB-PBCH design above. If the mode information is available, the UE can decide to take the LTE CRS REs into account or not in the NB-PBCH decoding process.

Specifically, the UE first achieves synchronization and obtain NB-PBCH TTI boundary at operation 3101. The UEs extract the first m (e.g., m=3) OFDM symbols in the subframes allocated for NB-PBCH transmission (as well as NB-PSS/SSS if included) at operation 3103. Based on pre-defined rule, the UEs try to detect additional information (e.g. mode indication signaling, or valid sequences only supported in guard-band and standalone) at operation 3105. Based on the detected information, the subsequent UE's behavior can be differentiated. For example, if it is in-band operation mode at operation 3107, in the subframes allocated for NB-PBCH transmission, the UEs extract the data symbols from the REs excluding the first m (e.g., m=3) OFDM symbols, and the REs allocated to LTE CRS and NB-IoT reference signals at operation 3111. If it is not in-band operation mode at operation 3107, in the subframes allocated for NB-PBCH transmission, the UEs extract the data symbols from the REs excluding the first m (e.g., m=3) OFDM symbols, and the REs allocated to NB-IoT reference signals at operation 3109. Then, the UE makes channel estimation and NB-PBCH demodulation at operation 3113, and finally obtain NB-PBCH payload and confirm the operation mode at operation 3115.

### Uplink Structure

In the NB-IoT uplink, the subframes with 15 kHz subcarrier spacing and 3.75 kHz subcarrier spacing can be multiplexed in the time domain, or in the frequency domain. For in-band deployments, some guard subcarriers can be configured to reduce the interference between subcarriers with different subcarrier spacing.

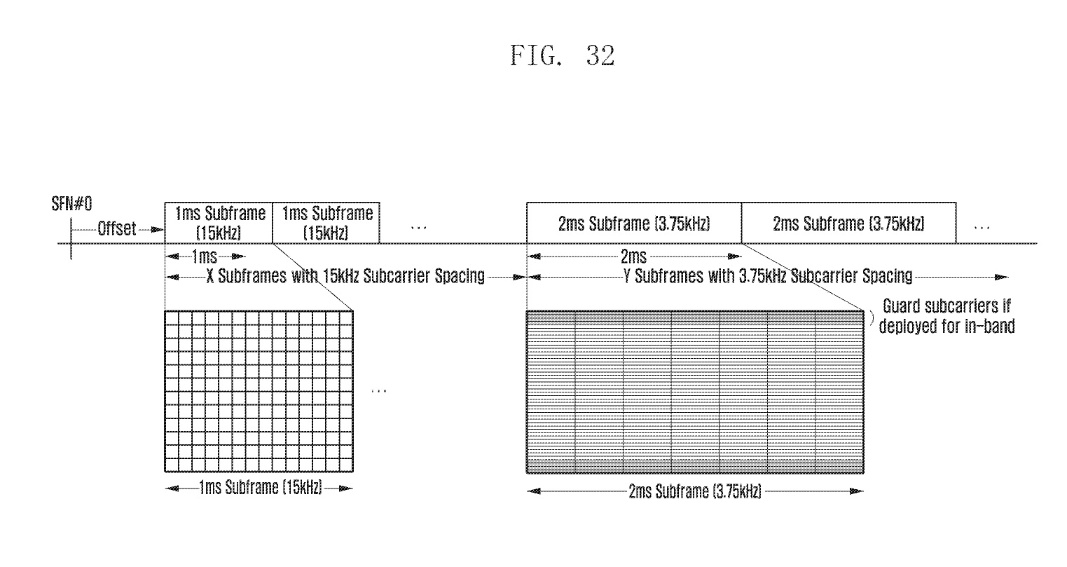

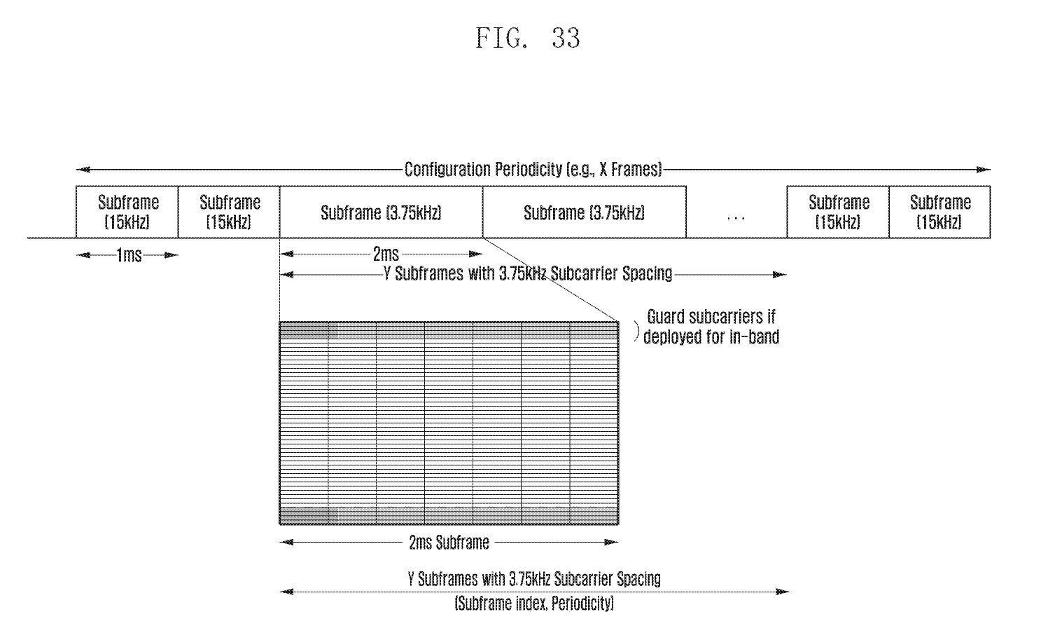

FIGS. 32 and 33 illustrate examples of NB-IoT uplink frame structures according to an embodiment of the present disclosure.

Referring to FIG. 32, if the subframes with 15 kHz subcarrier spacing and 3.75 kHz subcarrier spacing are multiplexed in the time domain, the subframes can be configured in a periodic manner, e.g., X consecutive subframes with 15 kHz subcarrier spacing, and then Y consecutive subframes with 3.75 kHz subcarrier spacing, and so on. The related configuration parameters can be signaled in the system information, e.g., X and Y. Or, some configuration sets and indices can be pre-defined, e.g., 0→(X0, Y0), 1→(X1, Y1), and so on. Thus, the configuration index can be signaled in the system information. It can be predefined that the configuration starts from the system frame number 0 (SFN#0). It is also possible to configure an offset of the subframe index to start the subframes of a pre-defined subcarrier spacing (e.g., 15 kHz), which can be signaled in the system information. Based on the above configuration, the UE can derive the exact subframe arrangement and indices of 15 kHz subcarrier spacing and 3.75 kHz subcarrier spacing in the time domain.

Alternatively, the system can only configure the information of subframe indices of one subcarrier spacing option (e.g., 3.75 kHz), and the remaining subframes are used by another subcarrier spacing option. For example in FIG. 33, the subframe indices and periodicity of the subframes with 3.75 kHz subcarrier spacing is configured in the system information, and the remaining subframes are used for 15 kHz subcarrier spacing. The subframe indices can be defined by a start subframe index and the number of consecutive subframes in the configured duration.

For LTE in-band operation, a pre-defined number of subcarriers in the subframes with 3.75 kHz subcarrier spacing can be configured as guard subcarrier to reduce the interference between LTE and NB-IoT. For example, 2 or 4 subcarriers (e.g., 7.5 kHz or 15 kHz) can be configured in both edge sides.

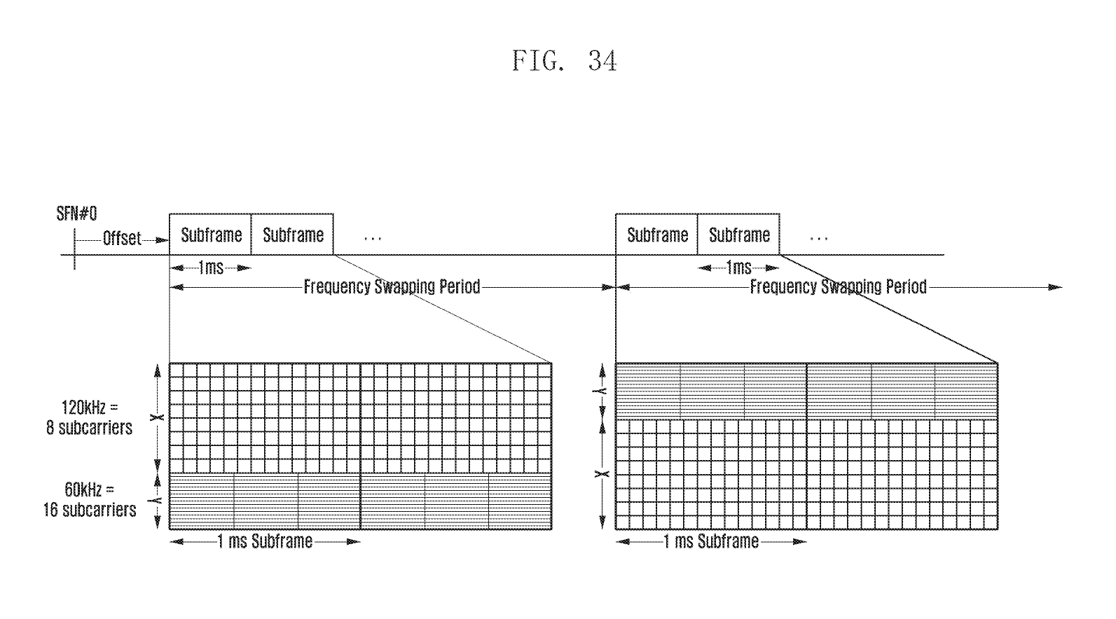

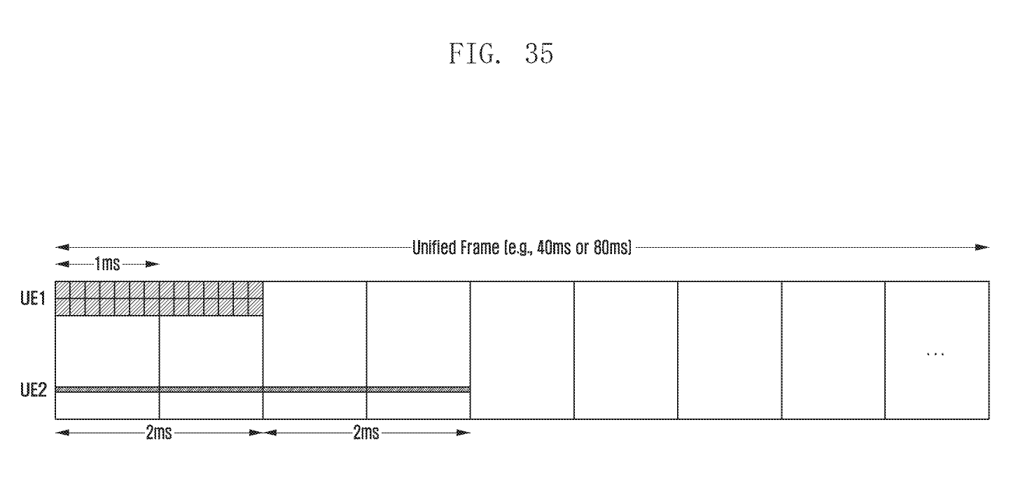

FIGS. 34 and 35 are other examples of NB-IoT uplink frame structure according to an embodiment of the present disclosure.

Referring to FIG. 34, if the subframes with 15 kHz subcarrier spacing and 3.75 kHz subcarrier spacing are multiplexed in the frequency domain, the bandwidth is composed of X contiguous subcarriers with 15 kHz subcarrier spacing and the Y contiguous subcarriers with 3.75 kHz subcarrier spacing. The related configuration parameters can be signaled in the system information, e.g., X and/or Y In addition, a frequency swapping period can be defined to swap the arrangement of subcarriers with two different spacing, as shown in FIG. 34. The offset and the frequency swapping period can be signaled in the system information.

It is also possible that the multiplexing between different subcarrier spacing options is transparent to UEs, and the multiplexing is up to BS implementation and scheduling. UEs follow the indicated subcarrier spacing and resource allocations scheduled by BS. It is also up to BS implementation to make the necessary guard band between different subcarrier spacing options via proper scheduling. Referring to FIG. 35, the transmission of UE1 is scheduled in two 15 kHz subcarriers, and the transmission of UE2 is scheduled in one 3.75 kHz subcarrier. How to multiplexing the transmissions are transparent to the UEs. The frequency hopping or swapping can be adopted if configured.

### LTE TDD Support

For in-band and guard-band operation modes, the longer slot or subframe with 3.75 kHz subcarrier spacing (e.g., 2 or 4 legacy subframes) works well in the LTE FDD mode. However, in the LTE TDD mode, the downlink and uplink subframes are multiplexed in the time domain.

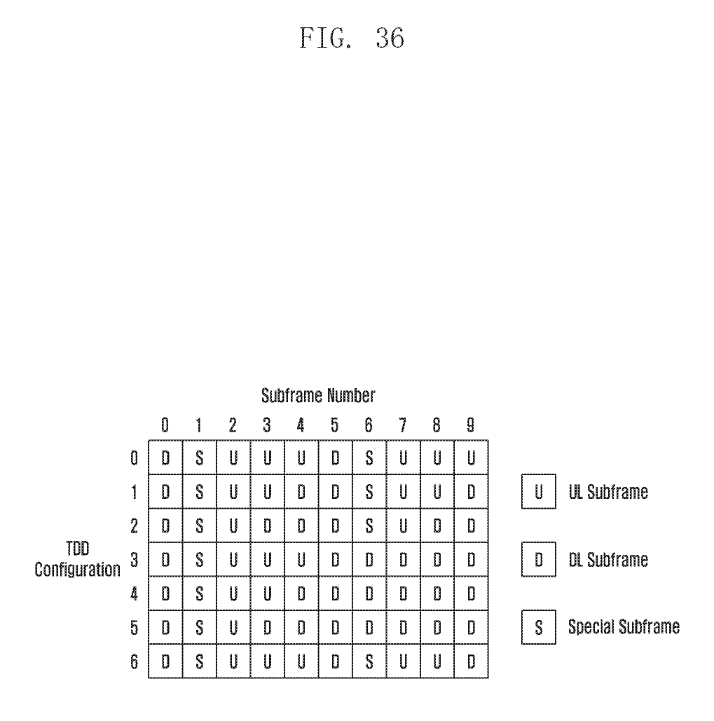

FIG. 36 shows LTE TDD Configurations according to an embodiment of the present disclosure.

As shown in the TDD configuration list in FIG. 36, consecutive 2 or 4 legacy LTE subframes are not always available to compose a compact slot or subframe for NB-IoT. Several approaches are proposed to support LTE TDD mode.

### Embodiment 1: Logical NB-IoT Slot/Subframe

Assume that the logical slot or subframe is composed by collecting the closest 2 or 4 uplink (UL) legacy subframes. Due to the discontinuity of the legacy subframes, the symbols may be segmented into discontinuous legacy subframes, if the last symbol boundary is not perfectly aligned with the legacy subframe boundary.

If the segmented symbol is a data symbol, the following solutions can be considered to handle the problem:

Discarding: Discard the segmented symbols for resource mapping, i.e., the segmented symbols are not counted in the resource mapping process

Puncturing: Puncture the segmented symbols, i.e., the segmented symbols are counted in the resource mapping process but not transmitted

If the segmented symbol is a demodulation reference signal (DMRS) symbol, the following solutions can be considered to handle the problem:

Discard the segmented DMRS symbols

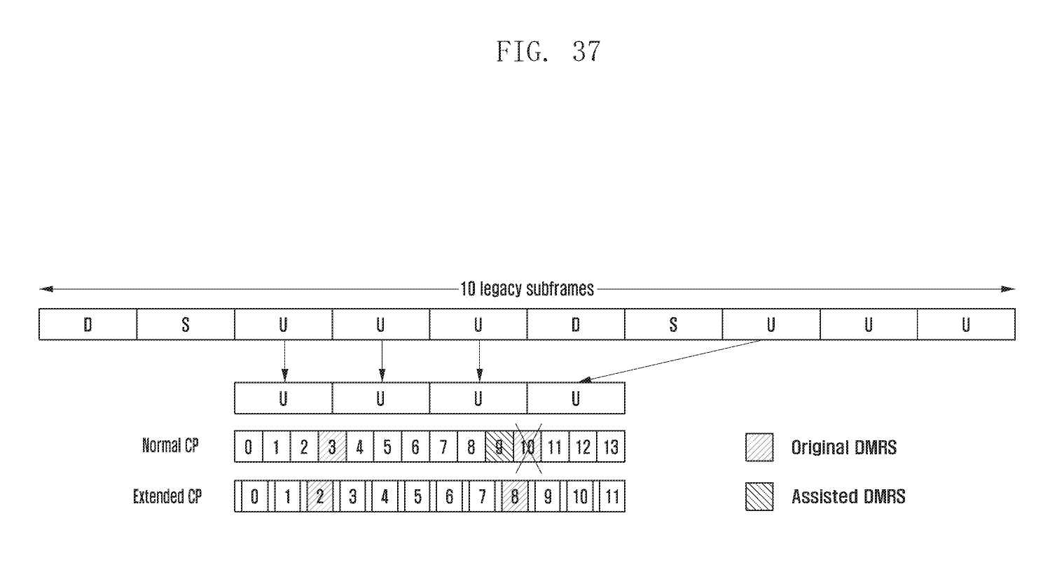

FIG. 37 shows an example of assisted DMRS due to the segmentation of original DMRS according to an embodiment of the present disclosure.

Discard the segmented DMRS symbols, and add assisted DMRS symbols in the adjacent symbols, e.g., one side or both sides, as shown in the example of FIG. 37.

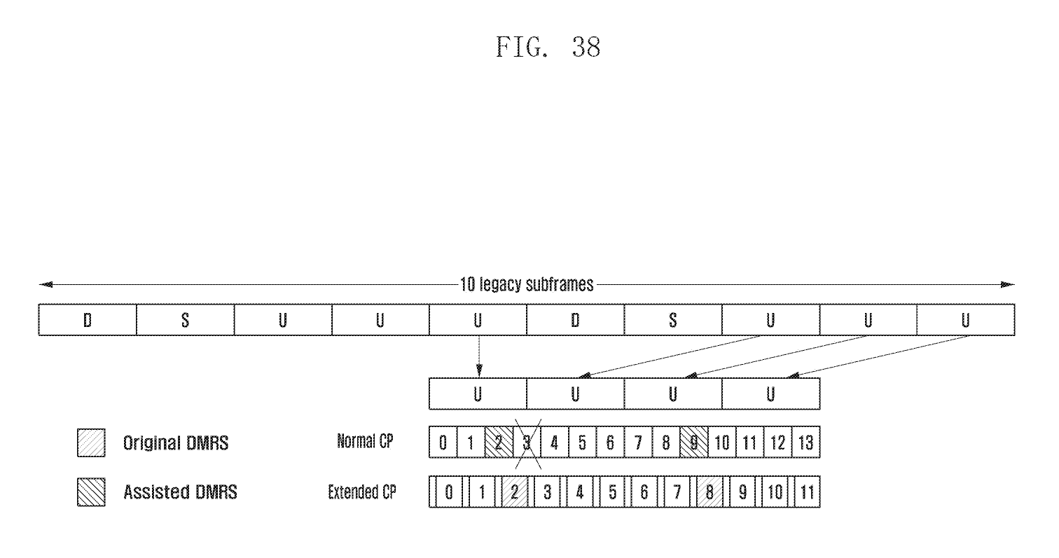

FIG. 38 shows an example of shifted DMRS symbols to avoid DMRS segmentation according to an embodiment of the present disclosure.

Shift the DMRS symbols to different locations to avoid symbol segmentation, as shown in the example of FIG. 38. The segmented data symbols follow the rule of discarding or puncturing in the resource mapping process

### Embodiment 2: Different Data/DMRS Arrangement for TDD

To handle the symbol segmentation problem in the TDD case, the data/DMRS symbols can be re-arranged for different consecutive legacy subframe options.

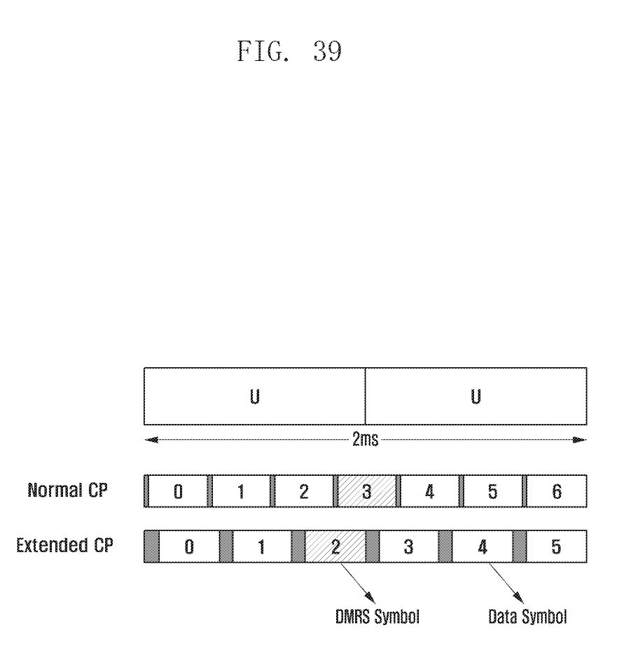

In the TDD mode, the number of continuous legacy UL subframes can be 1, 2 or 3. For the case of 2 continuous legacy UL subframes, the data/DMRS symbols can be arranged as shown in the example of FIG. 39.

FIG. 39 shows an example of data/DMRS symbol arrangement in 2 continuous legacy UL subframes according to an embodiment of the present disclosure.

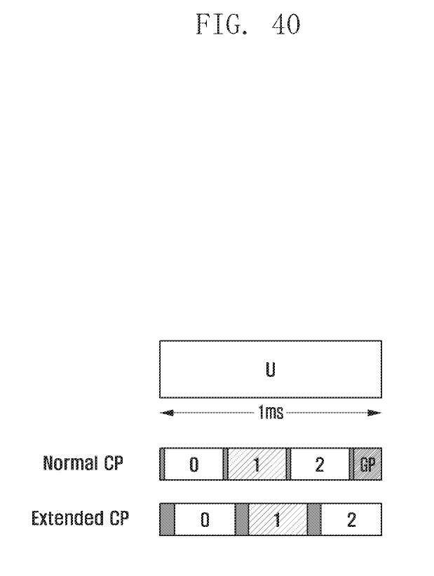

For the case of 1 legacy UL subframe, the data/DMRS symbols can be arranged as shown in the example of FIG. 40. In normal CP case, a guard period (GP) can be inserted to make up to a 1 ms subframe length. The location of GP can be adjusted based on the system design requirement.

FIG. 40 shows an example of data/DMRS symbol arrangement in 1 legacy UL subframe according to an embodiment of the present disclosure.

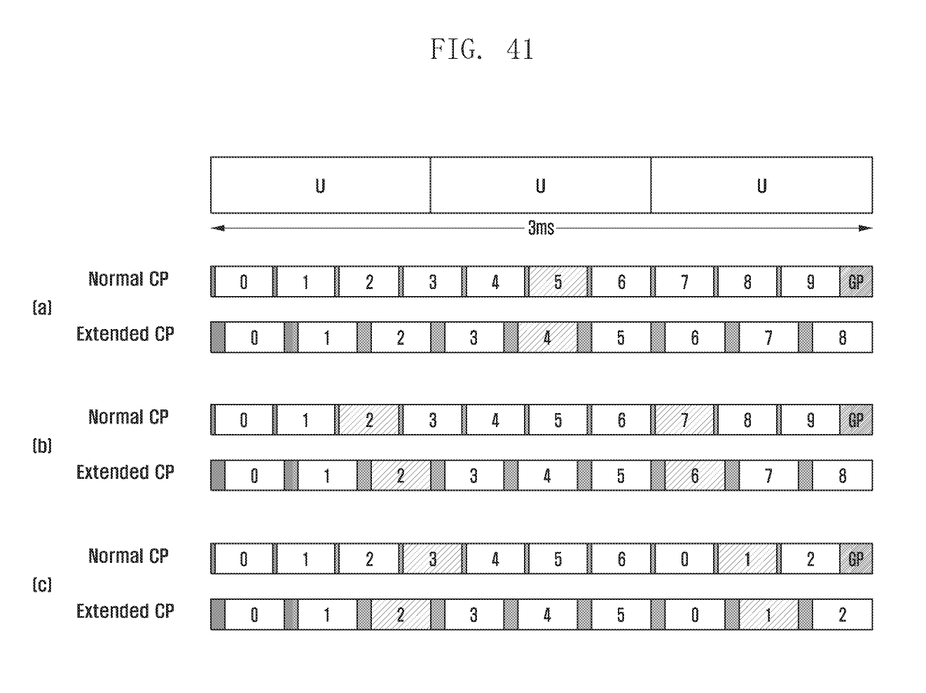

For the case of 3 consecutive legacy UL subframes, the data/DMRS symbols can be arranged as shown in the examples of FIG. 41. Three options are listed, where option (a) and (b) have different DRMS density, and option (c) is a kind of combination of formats for the cases of 1 and 2 UL subframes.

FIG. 41 shows an example of data/DMRS symbol arrangement in 3 consecutive legacy UL subframes according to an embodiment of the present disclosure.

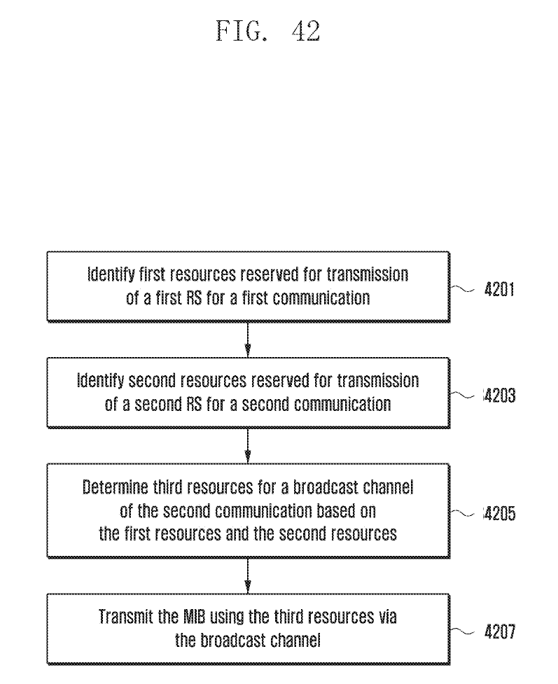

FIG. 42 illustrates a method of a BS for transmitting a MIB in a wireless communication network according to an embodiment of the present disclosure.

Referring to FIG. 42, the BS identifies first resources reserved for transmission of a first RS for a first communication using a first frequency bandwidth at operation 4201. The first RS may refer to LTE-CRS. The first communication may refer to legacy LTE operations. The BS identifies second resources reserved for transmission of a second RS for a second communication using a second frequency bandwidth at operation 4203. The second RS may refer to NB-RS. The second communication may refer to NB-IoT operation. The second frequency bandwidth (e.g., the frequency bandwidth of NB-IoT system) may be narrower than the first frequency bandwidth (e.g., the frequency of the legacy LTE system). The BS may identify a cell identifier for the second communication and identify the first resources based on the cell identifier. Indices of OFDM symbols carrying the second RS may correspond to last two indices in each slot of a subframe for the second communication, as shown in FIG. 24. The BS determines third resources for a broadcast channel of the second communication based on the first resources and the second resources at operation 4205. The broadcast channel of the second communication may refer to NB-PBCH. The BS may identify fourth resources for a control channel of the first communication, and determine the third resource upon further consideration of the fourth resources. The control channel of the first communication may refer to LTE PDCCH. The BS transmits the MIB using the third resources via the broadcast channel at operation 4207. The MIB may include information indicating an operation mode of the second communication.

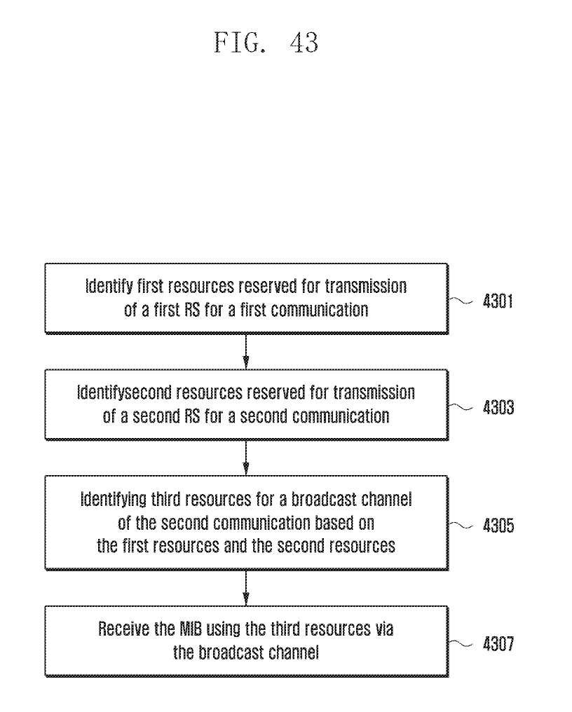

FIG. 43 illustrates a method of a wireless device for receiving a MIB in a wireless communication network according to an embodiment of the present disclosure.

Referring to FIG. 43, the wireless device identifies first resources reserved for transmission of a first RS for a first communication using a first frequency bandwidth at operation 4301. The first RS may refer to LTE-CRS. The first communication may refer to legacy LTE operations. The wireless device identifies second resources reserved for transmission of a second RS for a second communication using a second frequency bandwidth at operation 4303. The second RS may refer to NB-RS. The second communication may refer to NB-IoT operation. The second frequency bandwidth (e.g., the frequency bandwidth of NB-IoT system) may be narrower than the first frequency bandwidth (e.g., the frequency of the legacy LTE system). The wireless device may identify a cell identifier for the second communication and identify the first resources based on the cell identifier. Indices of OFDM symbols carrying the second RS may correspond to last two indices in each slot of a subframe for the second communication, as shown in FIG. 24. The wireless device identifies third resources for a broadcast channel of the second communication based on the first resources and the second resources at operation 4305. The broadcast channel of the second communication may refer to NB-PBCH. The wireless device may identify fourth resources for a control channel of the first communication, and identify the third resource upon further consideration of the fourth resources. The control channel of the first communication may refer to LTE PDCCH. The wireless device receives the MIB using the third resources via the broadcast channel at operation 4207. The MIB may include information indicating an operation mode of the wireless device for the second communication.

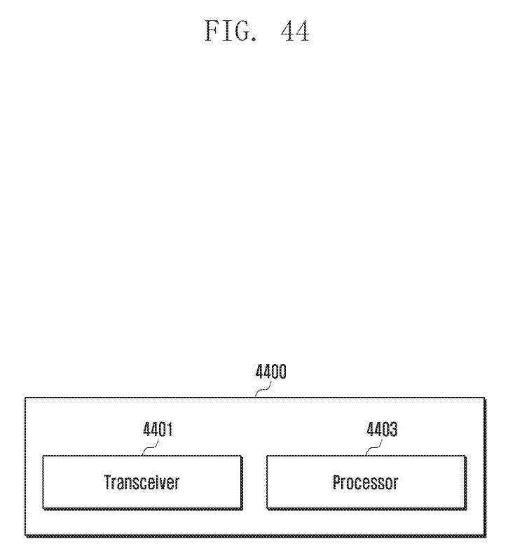

FIG. 44 is block diagram of a base station for transmitting a MIB in a wireless communication network according to an embodiment of the present disclosure.

Referring to FIG. 44, the base station (4400) includes a transceiver (4401) and a processor (4403). The transceiver (4401) performs data communication for the base station (4400). The transceiver (4401) may transmit a signal to the wireless device (4500) and receive a signal from the wireless device (4500). The processor (4403) may perform the steps of the method illustrated in FIG. 42. Specifically, the processor (4403) may identify the first resources reserved for transmission of the first RS for the first communication using the first frequency bandwidth, identify the second resources reserved for transmission of the second RS for the second communication using the second frequency bandwidth, determine the third resources for the broadcast channel of the second communication based on the first resources and the second resources, and transmit the MIB using the third resources via the broadcast channel.

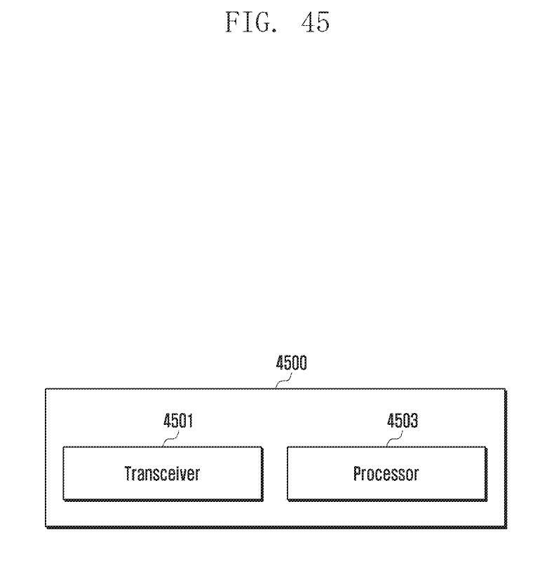

FIG. 45 is block diagram of a wireless device for receiving a MIB in the wireless communication network according to an embodiment of the present disclosure.

Referring to FIG. 45, the wireless device (4500) includes a transceiver (4501) and a processor (4503). The transceiver (4501) performs data communication for the wireless device (4500). The transceiver (4501) may transmit a signal to the base station (4400) and receive a signal from the base station (4400). The processor (4503) may perform the steps of the method illustrated in FIG. 43. Specifically, the processor (4503) may identify the first resources reserved for transmission of the first RS for the first communication using the first frequency bandwidth, identify the second resources reserved for transmission of the second RS for the second communication using the second frequency bandwidth, identify the third resources for the broadcast channel of the second communication based on the first resources and the second resources, and receive the MIB using the third resources via the broadcast channel.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of a base station (BS) for transmitting a master information block (MIB) in a wireless communication network, the method comprising:
identifying first resources reserved for transmission of a first reference signal (RS) for a first communication using a first frequency bandwidth;
identifying second resources reserved for transmission of a second RS for a second communication using a second frequency bandwidth, wherein the second frequency bandwidth is narrower than the first frequency bandwidth;
determining third resources for a broadcast channel of the second communication based on the first resources and the second resources; and
transmitting the MIB using the third resources via the broadcast channel.

2. The method of claim 1, further comprising:
identifying fourth resources for a control channel of the first communication,
wherein the third resources are determined based on the fourth resources.

3. The method of claim 1, wherein the identifying of the first resources comprises:
identifying a cell identifier for the second communication; and
identifying the first resources based on the cell identifier.

4. The method of claim 1, wherein the MIB includes information indicating an operation mode of the second communication.

5. The method of claim 1, wherein indices of orthogonal frequency-division multiplexing (OFDM) symbols carrying the second RS correspond to last two indices in each slot of a subframe for the second communication.

6. A method of a wireless device for receiving a master information block (MIB) in a wireless communication network, the method comprising:
identifying first resources reserved for transmission of a first reference signal (RS) for a first communication using a first frequency bandwidth;
identifying second resources reserved for transmission of a second RS for a second communication using a second frequency bandwidth, wherein the second frequency bandwidth is narrower than the first frequency bandwidth;
identifying third resources for a broadcast channel of the second communication based on the first resources and the second resources; and
receiving the MIB using the third resources via the broadcast channel.

7. The method of claim 6, further comprising:
identifying fourth resources for a control channel of the first communication,
wherein the third resources are identified based on the fourth resources.

8. The method of claim 6, wherein the identifying of the first resources comprises:
identifying a cell identifier for the second communication; and
identifying the first resources based on the cell identifier.

9. The method of claim 6, wherein the MIB includes information indicating an operation mode of the wireless device for the second communication.

10. The method of claim 6, wherein indices of orthogonal frequency-division multiplexing (OFDM) symbols carrying the second RS correspond to last two indices in each slot of a subframe for the second communication.

11. A base station for transmitting a master information block (MIB) in a wireless communication network, the base station comprising:
a transceiver configured to transmit and receive a signal; and
a processor configured to:
identify first resources reserved for transmission of a first reference signal (RS) for a first communication using a first frequency bandwidth;
identify second resources reserved for transmission of a second RS for a second communication using a second frequency bandwidth, wherein the second frequency bandwidth is narrower than the first frequency bandwidth;
determine third resources for a broadcast channel of the second communication based on the first resources and the second resources; and
transmit the MIB using the third resources via the broadcast channel.

12. The base station of claim 11, wherein the processor is further configured to identify fourth resources for a control channel of the first communication,
wherein the third resources are determined based on the fourth resources.

13. The base station of claim 11, wherein the processor is configured to identify the first resources by:
identifying a cell identifier for the second communication; and
identifying the first resources based on the cell identifier.

14. The base station of claim 11, wherein the MIB includes information indicating an operation mode of the second communication.

15. The base station of claim 11, wherein indices of orthogonal frequency-division multiplexing (OFDM) symbols carrying the second RS correspond to last two indices in each slot of a subframe for the second communication.

16. A wireless device for receiving a master information block (MIB) in a wireless communication network, the wireless device comprising:
a transceiver configured to transmit and receive a signal; and
a processor configured to:
identify first resources reserved for transmission of a first reference signal (RS) for a first communication using a first frequency bandwidth;
identify second resources reserved for transmission of a second RS for a second communication using a second frequency bandwidth, wherein the second frequency bandwidth is narrower than the first frequency bandwidth;
identify third resources for a broadcast channel of the second communication based on the first resources and the second resources; and
receive the MIB using the third resources via the broadcast channel.

17. The wireless device of claim 16, further comprising:
identifying fourth resources for a control channel of the first communication,
wherein the third resources are identified based on the fourth resources.

18. The wireless device of claim 16, wherein the processor is configured to identify the first resources by:
identifying a cell identifier for the second communication; and
identifying the first resources based on the cell identifier.

19. The wireless device of claim 16, wherein the MIB includes information indicating an operation mode of the wireless device for the second communication.

20. The wireless device of claim 16, wherein indices of orthogonal frequency-division multiplexing (OFDM) symbols carrying the second RS correspond to last two indices in each slot of a subframe for the second communication.
